(19) United States
(12) Patent Application Publication
(10) Pub. No.: US 2026/0181110 A1
(43) Pub. Date: Jun. 25, 2026

(54) PROJECTOR

(71) Applicant: SEIKO EPSON CORPORATION, Tokyo (JP)

(72) Inventors: Kazuhisa MIZUSAKO, SHIOJIRI-SHI (JP); Takuo YONEYAMA, AZUMINO-SHI (JP)

(73) Assignee: SEIKO EPSON CORPORATION, Tokyo (JP)

(21) Appl. No.: 19/422,491

(22) Filed: Dec. 17, 2025

(30) Foreign Application Priority Data
Dec. 19, 2024 (JP) 2024-223786

(51) Int. Cl. H04N 9/31; G03B 21/00

(52) U.S. Cl. CPC H04N 9/3111; H04N 9/3155; H04N 9/3164; H04N 9/3182; G03B 21/006; H04N 9/312

(57) ABSTRACT

A projector includes a first light source device configured to emit a first color light, a first liquid crystal panel having a plurality of lines, and a first light scanning device configured to scan the first color light along a column direction. In each of a plurality of subframes included in one frame, from a first line toward a last line, voltage corresponding to different color data is written for each one or a plurality of lines, the first color light is scanned from the first line toward the last line, a color light with corresponding to a color data is emitted from the first light source device as the first color light in a period in which voltage corresponding to color data is written.

The present application is based on, and claims priority from JP Application Serial Number 2024-223786, filed Dec. 19, 2024, the disclosure of which is hereby incorporated by reference herein in its entirety.

### BACKGROUND

### 1. Technical Field

The present disclosure relates to a projector.

### 2. Related Art

As a projector which is an image display device, there has been proposed a device that illuminates a liquid crystal panel with color light by temporally scanning illumination light emitted from a light source device on the modulation surface of the liquid crystal panel such as a liquid crystal panel and that projects image light emitted from the liquid crystal panel onto a projection surface such as a screen by a projection optical system.

For example, JP-A-2011-221500 discloses a projector in which a black display period is set within an image formation cycle of a vertical synchronization signal along a scanning direction in which liquid crystal panel illumination light of the liquid crystal panel is scanned. That is, in the projector disclosed in JP-A-2011-221500, the output of the light emitter of the light source device is controlled to be turned off during a period corresponding to at least one or more subframes among periods corresponding to a plurality of subframes of the liquid crystal panel.

In the related art, a projection image is formed by turning on the red, blue, and green light sources for each subframe, but if the light emission cycle (color rotation frequency) of each color light with respect to one frame period is fast, it is possible to suppress the occurrence of color breakup. However, when the color rotation frequency is increased, the drive frequency of the liquid crystal panel also needs to be increased. Under the condition that the drive frequency of the liquid crystal panel is substantially equal to the response speed of the liquid crystal, the color gamut and the brightness can be compatible, but the response speed of the liquid crystal is generally about 3 ms, which is quite slow. Therefore, when the color rotation frequency is increased, either color gamut or brightness is sacrificed.

For the above reasons, it is difficult to achieve both color gamut and brightness while reducing color breakup only by increasing the color rotation frequency.

### SUMMARY

A projector includes a first light source device configured to emit any one of red light, green light, and blue light as first color light; a first liquid crystal panel having a plurality of lines that are arranged at predetermined intervals along a column direction and that extend in a row direction, and in which the lines are defined as an array of pixels connected to one scanning line; and a first light scanning device configured to scan the first color light incident on the first liquid crystal panel along the column direction of the first liquid crystal panel, wherein in each of a plurality of subframes included in one frame, in the first liquid crystal panel, voltage corresponding to color data of any one of red data, green data, and blue data is written to the pixels belonging to each line in order from a first line toward a last line and also voltage corresponding to different color data is written for each of one or a plurality of lines, the first color light incident on the first liquid crystal panel is scanned from the first line toward the last line, in the first liquid crystal panel, the red light is emitted from the first light source device as the first color light in a period in which voltage corresponding to the red data is written, in the first liquid crystal panel, the green light is emitted from the first light source device as the first color light in a period in which voltage corresponding to the green data is written, and in the first liquid crystal panel, the blue light is emitted from the first light source device as the first color light in a period in which voltage corresponding to the blue data is written.

### BRIEF DESCRIPTION OF THE DRAWINGS

FIG. 1 is a schematic diagram of a projector according to a first embodiment.

FIG. 2 is a schematic diagram for explaining the behavior of a first light scanning device.

FIG. 3 is a schematic diagram for explaining the behavior of the first light scanning device.

FIG. 4 is a schematic diagram for explaining the behavior of the first light scanning device.

FIG. 5 is a timing chart showing an operation of a comparative example.

FIG. 6 is a timing chart showing the operation of the projector according to the first embodiment.

FIG. 7 is a timing chart showing an operation of a modification of the operation of the projector according to the first embodiment.

FIG. 8 is a timing chart showing the operation of the projector according to a second embodiment.

FIG. 9 is a timing chart showing the operation of the projector according to a third embodiment.

FIG. 10 is a schematic diagram of the projector according to a fourth embodiment.

FIG. 11 is a schematic diagram of the projector according to a fifth embodiment.

### DESCRIPTION OF EMBODIMENTS

Hereinafter, embodiments of the present disclosure will be described with reference to the drawings. In the drawings referred to below, the scale of dimensions may be changed depending on the components in order to make the components easy to see.

### First Embodiment

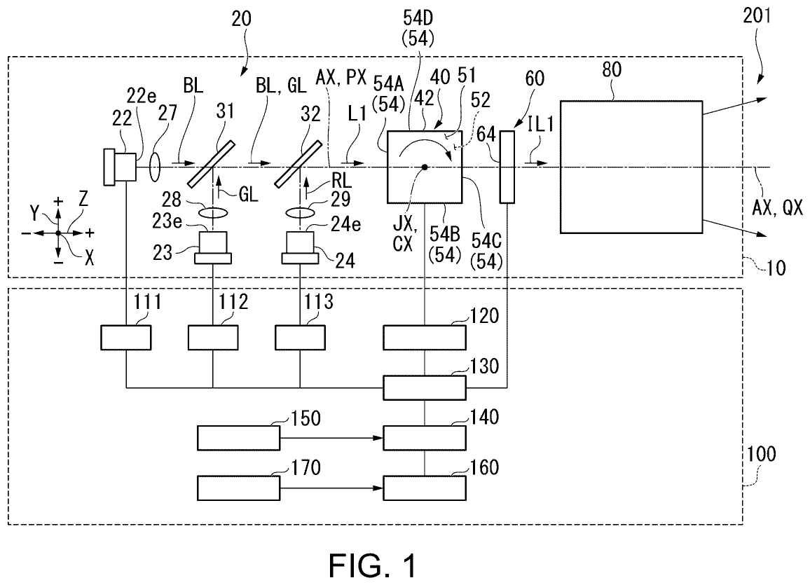

First, a first embodiment of the present disclosure will be described. FIG. 1 is a schematic diagram of a projector 201 according to the first embodiment. The projector 201 is a single-panel projector including one liquid crystal panel as a liquid crystal panel. As illustrated in FIG. 1, the projector 201 includes an optical device 10 and a control device 100. The optical device 10 includes a first light source device 20, a first light scanning device 40, a first liquid crystal panel 60, and a projection optical system 80.

The first light source device 20 emits any one of red light RL, green light GL, and blue light BL as a first color light L1. In the following description, assuming that a Z-axis is an axial direction parallel to an optical axis AX and a principal ray of a first color light L1 emitted from the first light source device 20, one side in a direction parallel to the Z-axis is a −Z side, and the other side in the direction parallel to the Z-axis is a +Z side. Assuming that an axis orthogonal to the Z-axis is an X-axis, one side in a direction parallel to the X-axis is a −X side, and the other side in the direction parallel to the X-axis is a +X side. Assuming that an axis orthogonal to the Z-axis and the X-axis is a Y-axis, one side in a direction parallel to the Y-axis is a −Y side, and the other side in the direction parallel to the Y-axis is a +Y side.

The first light source device 20 includes a light emitter 22 that emits the blue light BL, a light emitter 23 that emits the green light GL, a light emitter 24 that emits the red light RL, collimating lenses 27, 28, and 29, and dichroic mirrors 31 and 32.

The light emitter 22 emits the blue light BL from an emission surface 22e toward the +Z side along the Z-axis. The light emitter 22 is, for example, a blue Laser Diode (LD) or a blue Light Emitting Diode (LED).

The collimating lens 27 is disposed on the optical path of the blue light BL emitted from the light emitter 22, disposed at the same position as the emission surface 22e of the light emitter 22 in the X-axis and the Y-axis, and disposed on the +Z side of the emission surface 22e of the light emitter 22. A central axis of the collimating lens 27 overlaps an optical axis of the blue light BL emitted from the light emitter 22. The collimating lens 27 emits the blue light BL emitted from the light emitter 22 along the optical axis AX as parallel light parallel to the Z-axis.

The collimating lens 27 is, for example, a biconvex lens. Note that the collimating lens 27 may be a plano-convex lens having a flat incident surface parallel to the XY plane and an emission surface convex to the +Z side. In FIG. 1, the collimating lens 27 is disposed separated from the emission surface 22e of the light emitter 22, but if the collimating lens 27 is a plano-convex lens, the collimating lens 27 may be in contact with the emission surface 22e of the light emitter 22.

The light emitter 23 is disposed at the same position as the light emitter 22 in the X-axis, is disposed on the −Y side of the light emitter 22, and is disposed on the +Z side of the light emitter 22 and on the −Z side of a translucent member 42 of the first light scanning device 40. The light emitter 23 emits the green light GL from an emission surface 23e toward the +Y side along the Y-axis. The light emitter 23 is, for example, a green LD or a green LED.

The collimating lens 28 is disposed on the optical path of the green light GL emitted from the light emitter 23, is disposed at the same position as the emission surface 23e of the light emitter 23 in the X-axis and the Z-axis, and is disposed between the emission surface 23e of the light emitter 23 and the emission surface 22e of the light emitter 22 in the Y-axis. A central axis of the collimating lens 28 overlaps an optical axis of the green light GL emitted from the light emitter 23 and intersects the central axis of the collimating lens 27. The collimating lens 28 emits the green light GL emitted from the light emitter 23 to the +Y side as parallel light parallel to the Y-axis.

The collimating lens 28 is, for example, a biconvex lens. Note that the collimating lens 28 may be a plano-convex lens having a flat incident surface parallel to the XZ plane including the X-axis and the Z-axis and an emission surface convex to the +Y side. In FIG. 1, the collimating lens 28 is disposed separated from the emission surface 23e of the light emitter 23, but if the collimating lens 28 is a plano-convex lens, the collimating lens 28 may be in contact with the emission surface 23e of the light emitter 23.

The light emitter 24 is disposed at the same position as the light emitters 22 and 23 in the X-axis, is disposed on the −Y side of the light emitter 22, and is disposed on the +Z side of the light emitter 23 and on the −Z side of the translucent member 42 of the first light scanning device 40. The light emitter 24 emits the red light RL from an emission surface 24e toward the +Y side along the Y-axis. The light emitter 24 is, for example, a red LD or a red LED.

The collimating lens 29 is disposed on the optical path of the red light RL emitted from the light emitter 24, is disposed at the same position as the emission surface 24e of the light emitter 24 in the X-axis and the Z-axis, and is disposed between the emission surface 24e of the light emitter 24 and the emission surface 22e of the light emitter 22 in the Y-axis. A central axis of the collimating lens 29 overlaps an optical axis of the red light RL emitted from the light emitter 24 and intersects the central axis of the collimating lens 27. The collimating lens 29 emits the red light RL emitted from the light emitter 24 to the +Y side as parallel light parallel to the Y-axis.

The collimating lens 29 is, for example, a biconvex lens. Note that the collimating lens 29 may be a plano-convex lens having a flat incident surface parallel to the XZ plane including the X-axis and the Z-axis and an emission surface convex to the +Y side. In FIG. 1, the collimating lens 29 is disposed separated from the emission surface 24e of the light emitter 24, but if the collimating lens 29 is a plano-convex lens, the collimating lens 29 may be in contact with the emission surface 24e of the light emitter 24.

The dichroic mirror 31 is disposed in a region where the optical path of the blue light BL emitted from the collimating lens 27 and the optical path of the green light GL emitted from the collimating lens 28 overlap each other. The center of the dichroic mirror 31 in the XY plane substantially overlaps the intersection of the optical axis of the blue light BL emitted from the light emitter 22 and the optical axis of the green light GL emitted from the light emitter 23.

The dichroic mirror 31 has a reflection surface that transmits the blue light BL and reflects the green light GL. As viewed along the X-axis, the reflection surface of the dichroic mirror 31 inclines from the −Y side to the +Y side in accordance with distance from the −Z side to the +Z side. The blue light BL emitted from the collimating lens 27 is transmitted through the dichroic mirror 31 and emitted to the +Z side along the Z-axis. The green light GL emitted from the collimating lens 28 is incident on the dichroic mirror 31 and is reflected to the +Z side along the Z-axis by the reflection surface of the dichroic mirror 31.

The dichroic mirror 32 is disposed in a region where the optical paths of the blue light BL and the green light GL emitted from the dichroic mirror 31 and the optical path of the red light RL emitted from the collimating lens 29 overlap each other. The center of the dichroic mirror 32 in the XY plane substantially overlaps the intersection of the optical axis of the blue light BL emitted from the light emitter 22 and the optical axis of the red light RL emitted from the light emitter 24.

The dichroic mirror 32 has a reflection surface that transmits the blue light BL and the green light GL and reflects the red light RL. As viewed along the X-axis, the reflection surface of the dichroic mirror 32 inclines from the −Y side to the +Y side in accordance with distance from the −Z side to the +Z side. The blue light BL and the green light GL emitted from the dichroic mirror 32 are transmitted through the dichroic mirror 32 and emitted to the +Z side along the Z-axis. The red light RL emitted from the collimating lens 29 is incident on the dichroic mirror 32 and is reflected to the +Z side along the Z-axis by the reflection surface of the dichroic mirror 32.

As understood from the above description, in the case in which only the light emitter 22 emits light among the light emitters 22, 23, and 24, the blue light BL emitted from the light emitter 22 is emitted from the dichroic mirror 32 as the first color light L1. In the case in which only the light emitter 23 emits light among the light emitters 22, 23, and 24, the green light GL emitted from the light emitter 23 is emitted from the dichroic mirror 32 as the first color light L1. In a case where only the light emitter 24 emits light among the light emitters 22, 23, and 24, the red light RL emitted from the light emitter 24 is emitted from the dichroic mirror 32 as the first color light L1. As described above, the light emission periods of the light emitters 22, 23, and 24 are individually controlled, whereby any one of the red light RL, the green light GL, and the blue light BL is emitted from the first light source device 20 as the first color light L1. Note that the light emission period of the light emitters 22, 23, and 24 is controlled by the control device 100 (to be described later).

The first color light L1 is emitted from the first light source device 20 toward the +Z side along the optical axis AX, and is incident on the translucent member 42 of the first light scanning device 40. The first light scanning device 40 is disposed on the optical path of the first color light L1 emitted from the first light source device 20, and is disposed on the +Z side of the dichroic mirror 32. The first light scanning device 40 scans the first color light L1 incident on the first liquid crystal panel 60 along a column direction of the first liquid crystal panel 60. The column direction of the first liquid crystal panel 60 is a direction along the Y-axis.

The first light scanning device 40 includes the translucent member 42 and a rotation device such as a motor (not illustrated). The translucent member 42 is disposed on the optical path of the first color light L1 emitted from the first light source device 20, and is disposed on the +Z side of the dichroic mirror 32. The translucent member 42 is formed in a columnar shape. A central axis JX of the translucent member 42 is parallel to the X-axis, and intersects the optical axis AX or passes through the vicinity of the optical axis AX. The translucent member 42 is a polygonal columnar body having the central axis JX.

The translucent member 42 has two end surfaces 51 and 52 that intersect the central axis JX and are parallel to the YZ plane including the Y-axis and the Z-axis, and a plurality of side surfaces 54. The end surface 51 is disposed relatively on the +X side. The side surfaces 54 corresponding to an incident surface, an emission surface, and a second surface (to be described later) are disposed further toward the −X side than the end surface 51, and overlap the end surface 51 as viewed along the X-axis. The end surfaces 51 and 52 has a polygonal shape centered on the central axis JX.

The number of the side surfaces 54 is the same as the number of corners and the number of edges of the end surfaces 51 and 52. The side surfaces 54 connect the outer peripheral edges of the end surface 51 to the outer peripheral edges of the end surface 52 that overlap with the outer peripheral edges of the end surface 51 as viewed along the X-axis.

The end surfaces 51 and 52 have, for example, a regular quadrangular shape and have the same shape, size, and area as each other. The translucent member 42 has two end surfaces 51 and 52 and four side surfaces 54A, 54B, 54C, and 54D. The side surfaces 54A, 54B, 54C, and 54D have the same size and area. The size and area of the side surfaces 54A, 54B, 54C, and 54D are appropriately, in accordance with the scanning region of the first color light L1 as will be described later, larger than the irradiated area centered on the optical axis AX of the first color light L1 emitted from the first light source device 20.

As viewed along the X-axis, the side surfaces 54A and 54C face each other across the central axis JX and are parallel to each other. The side surfaces 54B and 54D face each other across the central axis JX and are parallel to each other. In the present specification, the expression “two side surfaces 54 are parallel to each other” means that the angle formed by the two side surfaces is in the range of 0° or more and 5° or less in consideration of the processing accuracy of the material of the translucent member 42, the allowable range of the parallelism of the first color light L1, and the like.

The translucent member 42 is disposed in a state of being rotatable around the central axis JX. The central axis JX corresponds to a rotation axis CX of the translucent member 42. The translucent member 42 transmits the first color light L1 incident from the −Z side along the Z-axis and the optical axis AX while rotating around a rotation axis CX, and emits the first color light LA to the +Z side.

In the present specification, a state in which the translucent member 42 is rotating around the rotation axis CX may be referred to as a rotation state. In the rotation state of the translucent member 42, the side surface 54 on which the first color light L1 emitted from the first light source device 20 is incident on the translucent member 42 is not fixed to one of the four side surfaces 54A, 54B, 54C, and 54D, but is one or two of the four side surfaces 54A, 54B, 54C, and, 54D and changes with time.

Note that the number of the side surfaces 54 of the translucent member 42 is not limited to four, and is desirably 2×m (m is a natural number equal to or greater than 2). When the number of the side surfaces 54 is an even number of four or more, all the side surfaces 54 are parallel to the side surfaces 54 facing the side surfaces 54, and the generation of the stray light of the first color light L1 transmitted through the translucent member 42 is suppressed, and the light use efficiency in the projector 201 is improved.

The material of the translucent member 42 is a material having light transmissivity with respect to the first color light L1, and is, for example, any of optical glasses such as BK7, which is borosilicate crown glass or B270, which is high-transparency crown glass, quarts, transparent resins, and the like.

The first liquid crystal panel 60 is disposed on the optical path of the first color light L1 emitted from the translucent member 42 of the first light scanning device 40 and in the region where the first color light L1 is scanned, and is disposed on the +Z side of the translucent member 42. The first liquid crystal panel 60 has a modulation surface 64 parallel to the XY plane. The position, size, area, and shape of the modulation surface 64 on the XY plane are equivalent to the region that can be irradiated with the first color light L1 by scanning the first color light L1 by the translucent member 42, and are equivalent to the range in which an appropriate margin region is secured outside an irradiation region with the first color light L1 on the XY plane.

The first liquid crystal panel 60 modulates the first color light L1 incident from the −Z side by the first light scanning device 40 with an electric signal input from the control device 100 (as will be described later) according to image information of a projection target, and converts the first color light LA into first image light IL1. The first liquid crystal panel 60 is, for example, a transmissive liquid crystal panel. The first liquid crystal panel 60 includes a plurality of pixels that are two dimensionally arranged along the X-axis and the Y-axis in the XY plane. The plurality of pixels of the first liquid crystal panel 60 constitute the modulation surface 64.

The plurality of pixels of the first liquid crystal panel 60 include switching elements. The switching element is, for example, a polysilicon Thin Film Transistor (TFT). The switching element of each pixel is supplied with an electric signal from the control device 100 that corresponds to the brightness or the light amount of each of the red light, the green light, and the blue light at the relative position of each pixel on the modulation surface 64 in the image of the projection target to be projected by the projector 201.

Each pixel of the first liquid crystal panel 60 modulates a vibration direction of the first color light L1 by operation of the switching elements according to the electric signals described above, and emits the modulated first color light L1 as the first image light IL1. The first liquid crystal panel 60 emits the first image light IL1, which is generated by modulating the first color light L1, toward the +Z side along the optical axis AX and the Z-axis.

The driving method of the first liquid crystal panel 60 is not particularly limited, but is, for example, a Twisted Nematic (TN) method, a Vertical Alignment (VA) method, or an In-Plane Switching (IPS) method.

The first liquid crystal panel 60 has a plurality of lines arranged at predetermined intervals along the column direction and extending in a row direction. The row direction of the first liquid crystal panel 60 is a direction along the X-axis. In the present specification, a “line” is defined as an array of pixels connected to one scanning line.

The projection optical system 80 is disposed on the optical path of the first image light IL1 outputted from the first liquid crystal panel 60 and is disposed on the +Z side of the first liquid crystal panel 60. The projection optical system 80 enlarges and projects the first image light IL1 generated by the first liquid crystal panel 60 toward a projection surface such as a screen. The projection optical system 80 is formed of a plurality of optical lenses disposed along the Z-axis. The optical lenses include, for example, a plano-convex lens, a plano-concave lens, a biconvex lens, a biconcave lens, a meniscus lens, an aspherical lens, a free-form surface lens, or the like.

An emission side polarizing plate (not illustrated) may be disposed on the optical path of the first image light IL1 between the first liquid crystal panel 60 and the projection optical system 80. The emission side polarizing plate transmits specific linearly polarized light of the first image light IL1 emitted from the first liquid crystal panel 60, and absorbs or reflects polarized light components other than the specific linearly polarized light. When an absorption-type polarizing plate is used as the emission side polarizing plate, the light that returns from the emission side polarizing plate to the −Z side is reduced, the generation of stray light in the projector 201 is suppressed, and the light use efficiency is improved.

The control device 100 controls the first light source device 20, the first light scanning device 40, and the first liquid crystal panel 60. The control device 100 includes light source output control devices 111, 112, and 113, a rotation control device 120, a drive control device 130, a central processing unit 140, a user interface 150, a video processing circuit 160, and a video interface 170.

The light source output control device 111 is electrically connected to the light emitter 22 of the first light source device 20 in a wired or wireless manner, and controls the light amount and the light emission period of the blue light BL emitted from the light emitter 22. Specifically, the light source output control device 111 outputs an electric signal related to a drive voltage or a drive current of the light emitter 22 to the light emitter 22 to control the light amount and the light emission period of the blue light BL. The light source output control device 111 is, for example, an LD driver or an LED driver. A driver, which is the light source output control device 111, stores and saves a program of a periodic drive voltage value or drive current value for the light emitter 22 corresponding to elapsed time and time t.

The light source output control device 112 is electrically connected to the light emitter 23 of the first light source device 20 in a wired or wireless manner, and controls the light amount and the light emission period of the green light GL emitted from the light emitter 23. Specifically, the light source output control device 112 outputs an electric signal related to a drive voltage or a drive current of the light emitter 23 to the light emitter 23 to control the light amount and the light emission period of the green light GL. The light source output control device 112 is, for example, an LD driver or an LED driver. A driver, which is the light source output control device 112, stores and saves a program of a periodic drive voltage value or drive current value for the light emitter 23 corresponding to elapsed time and time t.

The light source output control device 113 is electrically connected to the light emitter 24 of the first light source device 20 in a wired or wireless manner, and controls the light amount and the light emission period of the red light RL emitted from the light emitter 24. Specifically, the light source output control device 113 outputs an electric signal related to a drive voltage or a drive current of the light emitter 24 to the light emitter 24 to control the light amount and the light emission period of the red light RL. The light source output control device 113 is, for example, an LD driver or an LED driver. A driver, which is the light source output control device 113, stores and saves a program of a periodic drive voltage value or drive current value for the light emitter 24 corresponding to elapsed time and time t.

The rotation control device 120 is electrically connected to the translucent member 42 of the first light scanning device 40 via a motor in a wired or wireless manner, and controls the rotation speed of the translucent member 42 around the rotation axis CX. The rotation control device 120 is configured by, for example, a motor driver.

The drive control device 130 is electrically connected to the light source output control devices 111, 112, and 113 and the rotation control device 120, and is electrically connected to the first liquid crystal panel 60 in a wired or wireless manner. The drive control device 130 outputs electric signals to the light source output control devices 111, 112, and 113 and the rotation control device 120, to control the position, the region, and the timing on the XY plane where any one of the blue light BL, the green light GL, and the red light RL is scanned as the first color light L1 by the first light scanning device 40 and irradiated on the modulation surface 64 of the first liquid crystal panel 60. The drive control device 130 supplies an electric signal to each pixel on the modulation surface 64 in accordance with an irradiation position, the irradiation region, and the timing of the first color light L1 described above.

The drive control device 130 is, for example, a processor. The processor, which is the drive control device 130, stores and saves the timing of supplying the drive voltage values or the drive current values to the light emitters 22, 23, and 24, the timing of increasing or decreasing the rotation speed of the translucent member 42, and the timing of supplying the drive voltage of the modulated amount of the first color light L1 suitable for each pixel of the first liquid crystal panel 60.

The Central Processing Unit (CPU) 140 is electrically connected to the drive control device 130 in a wired or wireless manner. The central processing unit 140 transmits video information and drive information to the drive control device 130. The central processing unit 140 receives frame information from the video processing circuit 160, and receives information such as a refresh rate of the first liquid crystal panel 60 from a User Interface (UI) 150. The refresh rate of the first liquid crystal panel 60 is arbitrarily set by the user of the projector 201 from options provided in advance, and is, for example, 60 Hz and 90 Hz.

The user interface 150 is electrically connected to the central processing unit 140 in a wired or wireless manner. The user interface 150 transmits information such as the refresh rate to the central processing unit 140. The user interface 150 is, for example, an input device, a tablet terminal device, or the like installed in the projector 201.

The video processing circuit 160 is electrically connected to the central processing unit 140 by wire or wirelessly. The video processing circuit 160 receives the video information from the video interface 170, breaks down the received video information into frame information for each color, and transmits the frame information for each color of the video or the image to the central processing unit 140. The video processing circuit 160 has, for example, a Video Random Access Memory (VRAM), which is a memory dedicated to video processing.

The video interface 170 is electrically connected to the video processing circuit 160 in a wired or wireless manner. The video interface 170 transmits the image information and the video information of the projection target by the projector 201 to the video processing circuit 160.

Next, scanning of the first color light L1 by the first light scanning device 40 will be described. The translucent member 42 of the first light scanning device 40 rotates clockwise as indicated by an arrow, for example, around the rotation axis CX as viewed from the +X side, that is, from the front side of the paper surface of FIG. 1, toward the −X side, that is, toward the back side of the paper surface of FIG. 1.

FIG. 1 illustrates a first state, that is, an initial state in a rotation state of the translucent member 42 of the first light scanning device 40. In the first state, the side surface 54A of the translucent member 42 is positioned on the most -Z side among the four side surfaces 54 and is parallel to the XY plane. An angle formed counterclockwise from a virtual line TX, which passes through the central axis JX and the rotation axis CX and which is orthogonal to the side surface 54A, to an axis PX, which extends parallel to the Z-axis and toward the −Z side, with the central axis JX and the rotation axis CX as starting points is defined as a rotation angle ω. The actual first color light L1 has predetermined light beam widths on the X-axis, the Y-axis, and the XY plane. The description of the scanning and the behavior of the first color light L1 will focus on a light ray WBM on the optical axis AX of the first color light L1.

As illustrated in FIG. 1, in the first state, the rotation angle ω is 0°, and the first color light L1 incident on the translucent member 42 from the −Z side is incident perpendicularly to the side surface 54A, and thus is not refracted by the side surface 54A. The first color light L1 travels parallel to the Z-axis, is incident on the side surface 54C at a right angle, and is emitted from the side surface 54C to the +Z side along the Z-axis without being refracted by the side surface 54C. The light ray WBM of the first color light L1 passes through the center of the side surface 54A on the XY plane, the central axis JX, the rotation axis CX, and the center of the side surface 54C on the XY plane. A separation distance d on the Z-axis between the light ray WBM, which was emitted from the side surface 54C of the translucent member 42, and an axis QX, which extends in parallel with the Z-axis and toward the +Z side with the central axis JX and the rotation axis CX as the origin, is substantially zero.

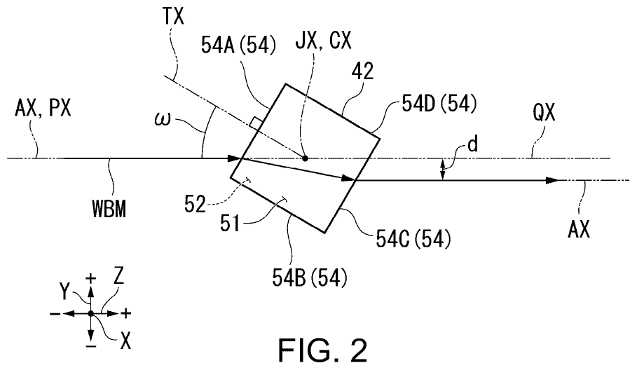

FIG. 2 is a schematic view of a second state in which the rotation of the translucent member 42 has advanced from the first state. As illustrated in FIG. 2, in the second state, the rotation angle ω is larger than 0° and smaller than 45°. In the second state, the first color light L1 incident on the translucent member 42 from the −Z side is incident on the side surface 54A at an incident angle equivalent to the narrow angle formed by the normal of the side surface 54A and the light ray WBM, and thus is refracted at the side surface 54A toward the −Y side with respect to the central axis JX in accordance with the incident angle on the side surface 54A, the refractive index n of the material of the translucent member 42, and Snell's law.

In the second state, the first color light L1 incident on the inside of the translucent member 42 as described above is refracted by the side surface 54A, is incident on the side surface 54C at an incident angle determined by the incident angle of the first color light L1 on the side surface 54A, the refractive index n, and Snell's law, is refracted by the side surface 54C, and is emitted from the side surface 54C to the +Z side along the Z-axis. The separation distance d in the second state is larger than the separation distance d in the first state.

In any state of the rotation of the translucent member 42, the one or two side surfaces 54 among the four side surfaces 54A, 54B, 54C, and 54D of the translucent member 42 on which the first color light L1 is incident, and the incident angle at which the first color light L1 is incident on one or two side surfaces 54, are determined according to the rotation angle ω. The separation distance d is determined by the incident angle of the first color light L1 on one or two side surfaces 54 accordance with the rotation angle ω, the refractive index n, and the distance on the Z-axis between the side surfaces 54A and 54C and between the side surfaces 54B and 54D, that is, the lengths of the sides of the polygon of the end surface 51 and 52.

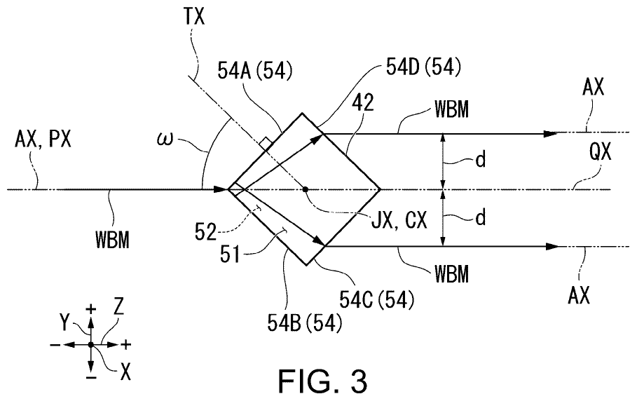

FIG. 3 is a schematic view of a third state in which the rotation of the translucent member 42 is further advanced from the second state. As illustrated in FIG. 3, the rotation angle ω is 45°, and the light ray WBM of the first color light L1 incident on the translucent member 42 from the −Z side is incident on the corner between the side surfaces 54A and 54B. In the third state, of the first color light L1 incident on the translucent member 42 from the −Z side, the first color light L1 that is further to the +Y side than the corner between the side surfaces 54A and 54B is, similarly to the second state, refracted by the side surface 54A, is incident on the side surface 54C at an incident angle determined by the incident angle of the first color light L1 on the side surface 54A, the refractive index n, and Snell's law, is refracted by the side surface 54C, and is emitted from the side surface 54C to the +Z side along the Z-axis.

In the third state, of the first color light L1 incident on the translucent member 42 from the −Z side, the first color light L1 further to the −Y side than the corner between the side surfaces 54A and 54B is refracted by the side surface 54B, is incident on the side surface 54D at an incident angle determined by the incident angle of the first color light L1 on the side surface 54B, the refractive index n, and Snell's law, is refracted by the side surface 54D, and is emitted from the side surface 54D to the +Z side along the Z-axis. The separation distance d in the third state is larger than the separation distance d in the second state.

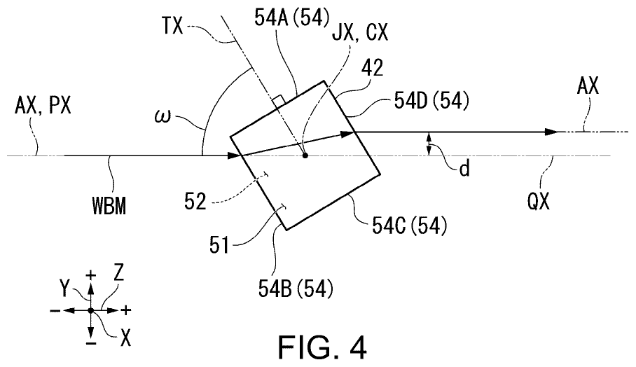

FIG. 4 is a schematic view of a fourth state in which the rotation of the translucent member 42 is further advanced from the third state. As illustrated in FIG. 4, in the fourth state, the rotation angle ω is larger than 45° and smaller than 90°. In the fourth state, the first color light L1 incident on the translucent member 42 from the −Z side is incident at an incident angle equivalent to the narrow angle formed by the perpendicular line of the side surface 54B and the light ray WBM, and thus is refracted to the +Y side from the central axis JX by the side surface 54B according to the incident angle to the side surface 54B, the refractive index n, and Snell's law.

In the fourth state, the first color light L1 incident on the inside of the translucent member 42 as described above is refracted by the side surface 54B, is incident on the side surface 54D at an incident angle determined by the incident angle of the first color light L1 on the side surface 54B, the refractive index n, and Snell's law, is refracted by the side surface 54D, and is emitted from the side surface 54D to the +Z side along the Z-axis. The separation distance d in the fourth state is smaller than the separation distance d in the third state.

Although not illustrated, when the rotation state of the translucent member 42 advances, the side surface 54A of the translucent member 42 is replaced with the side surface 54B and the side surface 54B is replaced with the side surface 54C with the behavior from the first state to the fourth state described above. Thereafter, in the behavior from the first state to the fourth state described above, the side surface 54A of the translucent member 42 is replaced with the side surface 54C, and the side surface 54B is replaced with the side surface 54D. Thereafter, in the behavior from the first state to the fourth state described above, the side surface 54A of the translucent member 42 is replaced with the side surface 54D, and the side surface 54B is replaced with the side surface 54A.

By this circulation of behavior, the first color light L1 emitted from the translucent member 42 of the first light scanning device 40 is scanned along the Y-axis (column direction of first liquid crystal panel 60). Since the beam width of the first color light L1 incident on the translucent member 42 in the X-axis is larger than the beam width in the Y-axis and equivalent to the size of the modulation surface 64 of the first liquid crystal panel 60 in the X-axis, the first color light L1 emitted from the translucent member 42 is scanned in the XY plane. In the behavior from the first state to the fourth state described above, the maximum value of the separation distance d is set to be equal to half the size of the modulation surface 64 on the Y-axis. In view of this, the length and size of one edge of the end surfaces 51 and 52 of the translucent member 42 and the refractive index n are appropriately set so that the maximum value of the separation distance d is equivalent to half the size of the modulation surface 64 on the Y-axis.

The above is the description related to the configuration of the projector 201. Hereinafter, before the operation of the projector 201 is described, an operation of a comparative example will be described in order to facilitate understanding of the operation of the projector 201. Since the operation of the comparative example can also be realized by the projector 201 configured as described above, the operation of the comparative example will be described below using the configuration of the projector 201 for convenience of description.

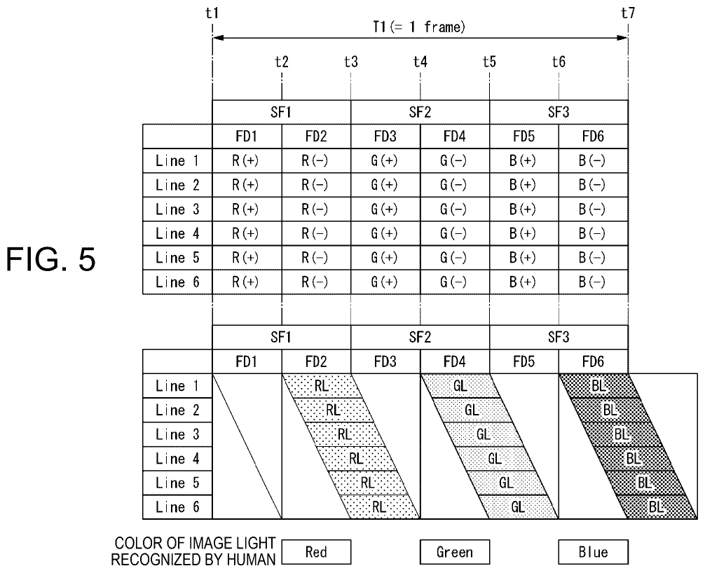

FIG. 5 is a timing chart showing an operation of the comparative example. In FIG. 5, a period T1 from a time t1 to a time t7 corresponds to one frame. One frame is equally divided into three subframes. One frame includes a first subframe SF1, a second subframe SF2, and a third subframe SF3. In FIG. 5, a period from the time t1 to the time t3 corresponds to the first subframe SF1, a period from the time t3 to the time t5 corresponds to the second subframe SF2, and a period from the time t5 to the time t7 corresponds to the third subframe SF3.

Each subframe is equally divided into two fields. The first subframe SF1 includes a first field FD1 that is a first half period of the first subframe SF1 and a second field FD2 that is a second half period of the first subframe SF1. The second subframe SF2 includes a third field FD3 that is a first half period of the second subframe SF2 and a fourth field FD4 that is a second half period of the second subframe SF2. The third subframe SF3 includes a fifth field FD5 that is a first half period of the third subframe SF3 and a sixth field FD6 that is a second half period of the third subframe SF3.

In FIG. 5, a period from the time t1 to the time t2 corresponds to the first field FD1, and a period from the time t2 to the time t3 corresponds to the second field FD2. The period from the time t3 to the time t4 corresponds to the third field FD3, and the period from the time t4 to the time t5 corresponds to the fourth field FD4. The period from the time t5 to the time t6 corresponds to the fifth field FD5, and the period from the time t6 to the time t7 corresponds to the sixth field FD6.

Odd-numbered fields including the first field FD1, the third field FD3, and the fifth field FD5 are periods in which voltage having a positive polarity is written to the pixels belonging to each line in order from the first line toward the last line in the first liquid crystal panel 60. Even-numbered fields including the second field FD2, the fourth field FD4, and the sixth field FD6 are periods in which voltage having a negative polarity is written to the pixels belonging to each line in order from the first line toward the last line in the first liquid crystal panel 60.

For example, the frame rate in the comparative example is 60 fps. That is, one frame corresponding to the period T1 from the time t1 to the time t7 is about 16.7 ms. In this case, the period of one field is about 2.78 ms. In the following description, the reciprocal of the period of one field is referred to as “drive frequency”. When the period of one field is about 2. 78 ms, the drive frequency of the first liquid crystal panel 60 is about 360 Hz.

In the comparative example, for convenience of description, it is assumed that the first liquid crystal panel 60 has six lines. In FIG. 5, “Line 1” represents the first line from the +Y side. The first line is an array of pixels connected to the first scanning line from the +Y side. “Line 2” represents the second line from the +Y side. The second line is an array of pixels connected to the second scanning line from the +Y side. “Line 3” represents the third line from the +Y side. The third line is an array of pixels connected to the third scanning line from the +Y side. “Line 4” represents the fourth line from the +Y side. The fourth line is an array of pixels connected to the fourth scanning line from the +Y side. “Line 5” represents the fifth line from the +Y side. The fifth line is an array of pixels connected to the fifth scanning line from the +Y side. “Line 6” represents the sixth line from the +Y side. The sixth line is an array of pixels connected to the sixth scanning line from the +Y side.

As shown in the timing chart in the upper part of FIG. 5, in the comparative example, in the first field FD1, voltage corresponding to red data and having a positive polarity is written to the pixels belonging to each line in order from the first line toward the sixth line, and in the second field FD2, voltage corresponding to red data and having a negative polarity is written to the pixels belonging to each line in order from the first line to the sixth line. In FIG. 5, voltage corresponding to red data and having a positive polarity is represented by “R (+)”, and voltage corresponding to red data and having a negative polarity is represented by “R (−)”. The red data is image data representing a red image included in an image of one frame.

As shown in the timing chart in the upper part of FIG. 5, in the comparative example, in the third field FD3, voltage corresponding to green data and having a positive polarity is written to the pixels belonging to each line in order from the first line toward the sixth line, and in the fourth field FD4, voltage corresponding to green data and having a negative polarity is written to the pixels belonging to each line in order from the first line to the sixth line. In FIG. 5, voltage corresponding to green data and having a positive polarity is represented by “G (+)”, and voltage corresponding to green data and having a negative polarity is represented by “G (−)”. The green data is image data representing a green image included in an image of one frame.

As shown in the timing chart in the upper part of FIG. 5, in the comparative example, in the fifth field FD5, voltage corresponding to blue data and having a positive polarity is written to the pixels belonging to each line in order from the first line toward the sixth line, and in the sixth field FD6, voltage corresponding to blue data and having a negative polarity is written to the pixels belonging to each line in order from the first line to the sixth line. In FIG. 5, voltage corresponding to the blue data and having a positive polarity is represented by “B (+)”, and voltage corresponding to the blue data and having a negative polarity is represented by “B (−)”. The blue data is image data representing a blue image included in an image of one frame.

As shown in the timing chart in the lower part of FIG. 5, in the comparative example, the red light RL is emitted from the first light source device 20 as the first color light L1 in the second field FD2. In the second field FD2, the red light RL emitted from the first light source device 20 is scanned by the first light scanning device 40 from the first line toward the sixth line along the modulation surface 64 of the first liquid crystal panel 60.

More specifically, the red light RL is irradiated to the first line in a period in which the “R (−)” voltage is written to the first line, the red light RL is irradiated to the second line in a period in which the “R (−)” voltage is written to the second line, and the red light RL is irradiated to the third line in a period in which the “R (−)” voltage is written to the third line. The red light RL is irradiated to the fourth line in a period in which the “R (−)” voltage is written to the fourth line, the red light RL is irradiated to the fifth line in a period in which the “R (−)” voltage is written to the fifth line, and the red light RL is irradiated to the sixth line in a period in which the “R (−)” voltage is written to the sixth line.

Since the timing at which the “R (−)” voltage starts to be written to the second line is later than the timing at which the “R (−)” voltage starts to be written to the first line, the timing at which the red light RL starts to be irradiated to the second line is later than the timing at which the red light RL starts to be irradiated to the first line. Since the timing at which the “R (−)” voltage starts to be written to the third line is later than the timing at which the “R (−)” voltage starts to be written to the second line, the timing at which the red light RL starts to be irradiated to the third line is later than the timing at which the red light RL starts to be irradiated to the second line. The same applies to the case where the fourth line to the sixth line are irradiated with the red light RL.

As shown in the timing chart in the lower part of FIG. 5, in the comparative example, the green light GL is emitted from the first light source device 20 as the first color light L1 in the fourth field FD4. In the fourth field FD4, the green light GL emitted from the first light source device 20 is scanned by the first light scanning device 40 from the first line toward the sixth line along the modulation surface 64 of the first liquid crystal panel 60.

More specifically, the green light GL is irradiated to the first line in a period in which the “G (−)” voltage is written to the first line, the green light GL is irradiated to the second line in a period in which the “G (−)” voltage is written to the second line, and the green light GL is irradiated to the third line in a period in which the “G (−)” voltage is written to the third line. The green light GL is irradiated to the fourth line in a period in which the “G (−)” voltage is written to the fourth line, the green light GL is irradiated to the fifth line in a period in which the “G (−)” voltage is written to the fifth line, and the green light GL is irradiated to the sixth line in a period in which the “G (−)” voltage is written to the sixth line.

Since the timing at which the “G (−)” voltage starts to be written in the second line is later than the timing at which the “G (−)” voltage starts to be written in the first line, the timing at which the green light GL starts to be irradiated on the second line is later than the timing at which the green light GL starts to be irradiated on the first line. Since the timing at which the “G (−)” voltage starts to be written to the third line is later than the timing at which the “G (−)” voltage starts to be written to the second line, the timing at which the green light GL starts to be irradiated to the third line is later than the timing at which the green light GL starts to be irradiated to the second line. The same applies to the case where the fourth line to the sixth line are irradiated with the green light GL.

As shown in the timing chart in the lower part of FIG. 5, in the comparative example, the blue light BL is emitted from the first light source device 20 as the first color light L1 in the sixth field FD6. In the sixth field FD6, the blue light BL outputted from the first light source device 20 is scanned by the first light scanning device 40 from the first line toward the sixth line along the modulation surface 64 of the first liquid crystal panel 60.

More specifically, the blue light BL is irradiated to the first line in a period in which the “B (−)” voltage is written to the first line, the blue light BL is irradiated to the second line in a period in which the “B (−)” voltage is written to the second line, and the blue light BL is irradiated to the third line in a period in which the “B (−)” voltage is written to the third line. The blue light BL is irradiated to the fourth line in a period in which the “B (−)” voltage is written to the fourth line, the blue light BL is irradiated to the fifth line in a period in which the “B (−)” voltage is written to the fifth line, and the blue light BL is irradiated to the sixth line in a period in which the “B (−)” voltage is written to the sixth line.

Since the timing at which the “B (−)” voltage starts to be written in the second line is later than the timing at which the “B (−)” voltage starts to be written in the first line, the timing at which the blue light BL starts to be irradiated on the second line is later than the timing at which the blue light BL starts to be irradiated on the first line. Since the timing at which the “B (−)” voltage starts to be written in the third line is later than the timing at which the “B (−)” voltage starts to be written in the second line, the timing at which the blue light BL starts to be irradiated on the third line is later than the timing at which the blue light BL starts to be irradiated on the second line. The same applies to the case where the fourth line to the sixth line are irradiated with the blue light BL.

As described above, in the comparative example, in order to suppress the occurrence of the crosstalk in the projection image, the first light source device 20 emits the first color light L1 only in the even-numbered fields, that is, only in the periods in which voltage having negative polarity is written. In the comparative example, the first image light IL1 projected in the second field FD2 is recognized by the human as red image light due to the integration effect (afterimage effect) of the eyes. The first image light IL1 projected in the fourth field FD4 is recognized by the human as green image light, and the first image light IL1 projected in the sixth field FD6 is recognized by the human as blue image light. As a result, the first image light IL1 projected in one frame is recognized by the human as a full-color image light.

As described above, in the comparative example, the red light RL, the green light GL, and the blue light BL are each emitted once from the first light source device 20 in one frame, that is, within 60 Hz. When the frequency at which each color light is emitted once from the first light source device 20 in one frame is defined as a “color rotation frequency”, the color rotation frequency in the comparative example is 60 Hz. According to the operation of the comparative example, since the color of the first image light IL1 is recognized by the human in the order of red, green, and blue in one frame, color breakup occurs when the color rotation frequency is 60 Hz.

For example, color breakup can be reduced by increasing the color rotation frequency. However, when the color rotation frequency is increased, the drive frequency of the first liquid crystal panel 60 also needs to be increased. For example, as described in the comparative example, when the color rotation frequency is 60Hz, the drive frequency of the first liquid crystal panel 60 is 360 Hz (period of one field is 2.78 ms). Therefore, when the color rotation frequency is doubled, the drive frequency of the first liquid crystal panel 60 needs to be 720 Hz (period of one field is 1.38 ms). When the color rotation frequency is tripled, the drive frequency of the first liquid crystal panel 60 needs to be 1080 Hz (period of one field is 0.93 ms).

Under the condition that the drive frequency of the first liquid crystal panel 60 is substantially equal to the response speed of the liquid crystal, both color gamut and brightness can be achieved, but the response speed of the liquid crystal is generally about 3 ms, which is quite slow. Therefore, when the color rotation frequency is increased by a factor of two or more, either color gamut or brightness is sacrificed. For the above reasons, in the operation of the comparative example, it is difficult to achieve both color gamut and brightness while reducing color breakup.

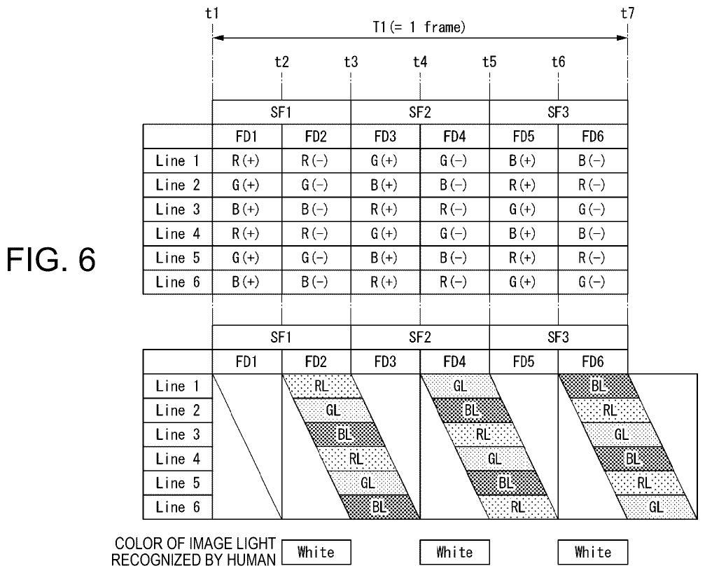

The operation of the projector 201 according to the first embodiment, both color gamut and brightness can be achieved while reducing color breakup. The operation of the projector 201 according to the first embodiment will be described below with reference to FIG. 6.

FIG. 6 is a timing chart showing the operation of the projector 201 according to the first embodiment. As in FIG. 5, in FIG. 6, a period T1 from a time t1 to a time t7 corresponds to one frame. As in the comparative example, in the first embodiment, one frame is equally divided into three subframes. One frame includes a first subframe SF1, a second subframe SF2, and a third subframe SF3. In FIG. 6, a period from the time t1 to the time t3 corresponds to the first subframe SF1, a period from the time t3 to the time t5 corresponds to the second subframe SF2, and a period from the time t5 to the time t7 corresponds to the third subframe SF3.

As in the comparative example, in the first embodiment, each subframe is equally divided into two fields. The first subframe SF1 includes a first field FD1 that is a first half period of the first subframe SF1 and a second field FD2 that is a second half period of the first subframe SF1. The second subframe SF2 includes a third field FD3 that is a first half period of the second subframe SF2 and a fourth field FD4 that is a second half period of the second subframe SF2. The third subframe SF3 includes a fifth field FD5 that is a first half period of the third subframe SF3 and a sixth field FD6 that is a second half period of the third subframe SF3.

In FIG. 6, a period from the time t1 to the time t2 corresponds to the first field FD1, and a period from the time t2 to the time t3 corresponds to the second field FD2. The period from the time t3 to the time t4 corresponds to the third field FD3, and the period from the time t4 to the time t5 corresponds to the fourth field FD4. The period from the time t5 to the time t6 corresponds to the fifth field FD5, and the period from the time t6 to the time t7 corresponds to the sixth field FD6.

As in the comparative example, in the first embodiment, the odd-numbered fields including the first field FD1, the third field FD3, and the fifth field FD5 are periods in which voltage having positive polarity is written to each line in order from the first line to the last line in the first liquid crystal panel 60. The even-numbered fields including the second field FD2, the fourth field FD4, and the sixth field FD6 are periods in which voltage having a negative polarity is written to each line in order from the first line toward the last line in the first liquid crystal panel 60.

For example, the frame rate in the first embodiment is 60 fps. That is, one frame corresponding to the period T1 from the time t1 to the time t7 is about 16.7 ms. In this case, the period of one field is about 2.78 ms. That is, in the first embodiment, the drive frequency of the first liquid crystal panel 60 is about 360 Hz.

Similarly to the comparative example, in the first embodiment, for convenience of description, it is assumed that the first liquid crystal panel 60 has six lines. In FIG. 6, “Line 1” represents the first line from the +Y side. “Line 2” represents the second line from the +Y side. “Line 3” represents the third line from the +Y side. “Line 4” represents the fourth line from the +Y side. “Line 5” represents the fifth line from the +Y side. “Line 6” represents the sixth line from the +Y side.

In the first embodiment, the first line is a line included in the first group. The second line is a line included in the second group. The third line is a line included in the third group. The fourth line is a line included in a fourth group. The fifth line is a line included in a fifth group. The sixth line is a line included in a sixth group. As described above, in the first embodiment, the plurality of lines included in the first liquid crystal panel 60 are divided into a plurality of groups each including one or a plurality of lines. As described above, in the first embodiment, as an example, a case where each group includes one line will be described, but each group may include a plurality of lines. However, the number of lines included in each group needs to be the same.

For example, when each group includes two lines, the first group includes a first line and a second line, the second group includes a third line and a fourth line, the third group includes a fifth line and a sixth line, the fourth group includes a seventh line and an eighth line, the fifth group includes a ninth line and a tenth line, and the sixth group includes an eleventh line and a twelfth line. In this manner, the plurality of lines included in the first liquid crystal panel 60 are divided into a plurality of groups including one or a plurality of lines, which is the same in a second embodiment and a third embodiment described below.

As shown in the timing chart in the upper part of FIG. 6, in the first embodiment, in each of the three subframes, voltage corresponding to color data of any one of the red data, the green data, and the blue data is written to pixels belonging to each line in order from the first line toward the sixth line (the last line), and voltage corresponding to different color data is written to each line. When each group includes a plurality of lines, voltage corresponding to different color data for each of the plurality of lines is written in each subframe.

In the odd-numbered fields, voltage corresponding to different color data for each line and having a positive polarity is written. In the even-numbered field, voltage corresponding to different color data for each line and having a negative polarity is written. Positive polarity is an example of a first polarity. Negative polarity is an example of a second polarity that is a polarity opposite to the first polarity. When each group includes a plurality of lines, voltage corresponding to different color data for each of the plurality of lines and having a positive polarity is written in the odd-numbered fields, and voltage corresponding to different color data for each of the plurality of lines and having a negative polarity is written in the even-numbered fields.

In particular, in the first field FD1, a voltage (“R (+)”) corresponding to the red data and having a positive polarity is written to the first line. In the first field FD1, a voltage (“G (+)”) corresponding to the green data and having a positive polarity is written to the second line. In the first field FD1, a voltage (“B (+)”) corresponding to the blue data and having a positive polarity is written to the third line.

In the first field FD1, a voltage (“R (+)”) corresponding to the red data and having a positive polarity is written to the fourth line. In the first field FD1, a voltage (“G (+)”) corresponding to the green data and having a positive polarity is written to the fifth line. In the first field FD1, a voltage (“B (+)”) corresponding to the blue data and having a positive polarity is written to the sixth line.

In the second field FD2, a voltage (“R (−)”) corresponding to the red data and having a negative polarity is written to the first line. In the second field FD2, a voltage (“G (−)”) corresponding to the green data and having a negative polarity is written to the second line. In the second field FD2, a voltage (“B (−)”) corresponding to the blue data and having a negative polarity is written to the third line.

In the second field FD2, a voltage (“R (−)”) corresponding to the red data and having a negative polarity is written to the fourth line. In the second field FD2, a voltage (“G (−)”) corresponding to the green data and having a negative polarity is written to the fifth line. In the second field FD2, a voltage (“B (−)”) corresponding to the blue data and having a negative polarity is written to the sixth line.

In the third field FD3, a voltage (“G (+)”) corresponding to the green data and having a positive polarity is written to the first line. In the third field FD3, a voltage (“B (+)”) corresponding to the blue data and having a positive polarity is written to the second line. In the third field FD3, a voltage (“R (+)”) corresponding to the red data and having a positive polarity is written to the third line.

In the third field FD3, a voltage (“G (+)”) corresponding to the green data and having a positive polarity is written to the fourth line. In the third field FD3, a voltage (“B (+)”) corresponding to the blue data and having a positive polarity is written to the fifth line. In the third field FD3, a voltage (“R (+)”) corresponding to the red data and having a positive polarity is written to the sixth line.

In the fourth field FD4, a voltage (“G (−)”) corresponding to the green data and having a negative polarity is written to the first line. In the fourth field FD4, a voltage (“B (−)”) corresponding to the blue data and having a negative polarity is written to the second line. In the fourth field FD4, a voltage (“R (−)”) corresponding to the red data and having a negative polarity is written to the third line.

In the fourth field FD4, a voltage (“G (−)”) corresponding to the green data and having a negative polarity is written to the fourth line. In the fourth field FD4, a voltage (“B (−)”) corresponding to the blue data and having a negative polarity is written to the fifth line. In the fourth field FD4, a voltage (“R (−)”) corresponding to the red data and having a negative polarity is written to the sixth line.

In the fifth field FD5, a voltage (“B (+)”) corresponding to the blue data and having a positive polarity is written to the first line. In the fifth field FD5, a voltage (“R (+)”) corresponding to the red data and having a positive polarity is written to the second line. In the fifth field FD5, a voltage (“G (+)”) corresponding to the green data and having a positive polarity is written to the third line.

In the fifth field FD5, a voltage (“B (+)”) corresponding to the blue data and having a positive polarity is written to the fourth line. In the fifth field FD5, a voltage (“R (+)”) corresponding to the red data and having a positive polarity is written to the fifth line. In the fifth field FD5, a voltage (“G (+)”) corresponding to the green data and having a positive polarity is written to the sixth line.

In the sixth field FD6, a voltage (“B (−)”) corresponding to the blue data and having a negative polarity is written to the first line. In the sixth field FD6, a voltage (“R (−)”) corresponding to the red data and having a negative polarity is written to the second line. In the sixth field FD6, a voltage (“G (−)”) corresponding to the green data and having a negative polarity is written to the third line.

In the sixth field FD6, a voltage (“B (−)”) corresponding to the blue data and having a negative polarity is written to the fourth line. In the sixth field FD6, a voltage (“R (−)”) corresponding to the red data and having a negative polarity is written to the fifth line. In the sixth field FD6, a voltage (“G (−)”) corresponding to the green data and having a negative polarity is written to the sixth line.

As shown in the timing chart in the lower part of FIG. 6, in the first embodiment, in each of the three subframes, the first color light L1 incident on the first liquid crystal panel 60 is scanned from the first line toward the sixth line. In the first liquid crystal panel 60, the red light RL is emitted from the first light source device 20 as the first color light L1 in a period in which voltage corresponding to the red data is written. In the first liquid crystal panel 60, the green light GL is emitted from the first light source device 20 as the first color light L1 in a period in which voltage corresponding to the green data is written. In the first liquid crystal panel 60, the blue light BL is emitted from the first light source device 20 as the first color light L1 in a period in which voltage corresponding to the blue data is written. In the odd-numbered field, the emission of the first color light L1 from the first light source device 20 is stopped. In the even-numbered fields, the first color light L1 incident on the first liquid crystal panel 60 is scanned from the first line toward the sixth line.

Specifically, in the second field FD2, the red light RL is irradiated to the first line in a period in which the “R (−)” voltage is written to the first line, the green light GL is irradiated to the second line in a period in which the “G (−)” voltage is written to the second line, and the blue light BL is irradiated to the third line in a period in which the “B (−)” voltage is written to the third line.

In the second field FD2, the red light RL is irradiated to the forth line in a period in which the “R (−)” voltage is written to the fourth line, the green light GL is irradiated to the fifth line in a period in which the “G (−)” voltage is written to the fifth line, and the blue light BL is irradiated to the sixth line in a period in which the “B (−)” voltage is written to the sixth line.

In the second field FD2, since the timing at which the “G (−)” voltage starts to be written to the second line is later than the timing at which the “R (−)” voltage starts to be written to the first line, the timing at which the green light GL starts to be irradiated to the second line is later than the timing at which the red light RL starts to be irradiated to the first line. Since the timing at which the “B (−)” voltage starts to be written in the third line is later than the timing at which the “G (−)” voltage starts to be written in the second line, the timing at which the blue light BL starts to be irradiated on the third line is later than the timing at which the green light GL starts to be irradiated on the second line. The same applies to the case where the first color light L1 is irradiated to the fourth line to the sixth line in the second field FD2.

In the fourth field FD4, the green light GL is irradiated to the first line in a period in which the “G (−)” voltage is written to the first line, the blue light BL is irradiated to the second line in a period in which the “B (−)” voltage is written to the second line, and the red light RL is irradiated to the third line in a period in which the “R (−)” voltage is written to the third line.

In the fourth field FD4, the green light GL is irradiated to the fourth line in a period in which the “G (−)” voltage is written to the fourth line, the blue light BL is irradiated to the fifth line in a period in which the “B (−)” voltage is written to the fifth line, and the red light RL is irradiated the sixth line in a period in which the “R (−)” voltage is written to the sixth line.

In the fourth field FD4, since the timing at which the “B (−)” voltage starts to be written to the second line is later than the timing at which the “G (−)” voltage starts to be written to the first line, the timing at which the blue light BL starts to be irradiated to the second line is later than the timing at which the green light GL starts to be irradiated to the first line. Since the timing at which the “R (−)” voltage starts to be written to the third line is later than the timing at which the “B (−)” voltage starts to be written to the second line, the timing at which the red light RL starts to be irradiated to the third line is later than the timing at which the blue light BL starts to be irradiated to the second line. The same applies to the case where the first color light L1 is irradiated to the fourth line to the sixth line in the fourth field FD4.

In the sixth field FD6, the blue light BL is irradiated to the first line in a period in which the “B (−)” voltage is written to the first line, the red light RL is irradiated to the second line in a period in which the “R (−)” voltage is written to the second line, and the green light GL is irradiated to the third line in a period in which the “G (−)” voltage is written to the third line.

In the sixth field FD6, the blue light BL is irradiated to the fourth line in a period in which the “B (−)” voltage is written to the fourth line, the red light RL is irradiated to the fifth line in a period in which the “R (−)” voltage is written to the fifth line, and the green light GL is irradiated to the sixth line in a period in which the “G (−)” voltage is written to the sixth line.

In the sixth field FD6, since the timing at which the “R (−)” voltage starts to be written to the second line is later than the timing at which the “B (−)” voltage starts to be written to the first line, the timing at which the red light RL starts to be irradiated to the second line is later than the timing at which the blue light BL starts to be irradiated to the first line. Since the timing at which the “G (−)” voltage starts to be written in the third line is later than the timing at which the “R (−)” voltage starts to be written in the second line, the timing at which the green light GL starts to be irradiated on the third line is later than the timing at which the red light RL starts to be irradiated on the second line. The same applies to the case where the first color light L1 is irradiated to the fourth line to the sixth line in the sixth field FD6.

According to the operation of the first embodiment as described above, the first image light IL1 projected in the second field FD2 is recognized by the human as white image light due to the integration effect of the eyes. The first image light IL1 projected in the fourth field FD4 is also recognized by the human as white image light, and the first image light IL1 projected in the sixth field FD6 is also recognized by the human as white image light. As a result, the first image light IL1 projected in one frame is recognized by the human as a full-color image light.

As described above, according to the operation of the comparative example, in one frame, the color of the first image light IL1 is recognized by the human in the order of red, green, and blue, and thus, color breakup occurs when the color rotation frequency is 60 Hz. On the other hand, according to the operation of the first embodiment, since the color of the first image light IL1 is recognized by the human in the order of white, white, and white in one frame, even when the color rotation frequency is 60 Hz, color breakup can be reduced. That is, according to the first embodiment, both color gamut and the brightness can be achieved while reducing color breakup.

As described above, the projector 201 according to the first embodiment includes the first light source device 20 that emits one of the red light RL, the green light GL, and the blue light BL as the first color light L1, the first liquid crystal panel 60 having the plurality of lines that are arranged at predetermined intervals along the column direction and that extend in the row direction, and in which the lines are defined as an array of the pixels connected to one scanning line, and the first light scanning device 40 that scans the first color light L1 incident on the first liquid crystal panel 60 along the column direction of the first liquid crystal panel 60. in each of a plurality of subframes included in one frame, in the first liquid crystal panel 60, voltage corresponding to the color data of any one of the red data, the green data, and the blue data is written to the pixels belonging to each line in order from the first line toward the last line, and voltage corresponding to different color data is written for each one or the plurality of lines (each line in the present embodiment), the first color light L1 incident on the first liquid crystal panel 60 is scanned from the first line toward the last line, in the first liquid crystal panel 60, the red light RL is emitted from the first light source device 20 as the first color light L1 in a period in which voltage corresponding to the red data is written, in the first liquid crystal panel 60, the green light GL is emitted from the first light source device 20 as the first color light L1 in a period in which voltage corresponding to the green data is written, and in the first liquid crystal panel 60, the blue light BL is emitted from the first light source device 20 as the first color light L1 in a period in which voltage corresponding to the blue data is written.

According to the first embodiment as described above, since the color of the first image light IL1 is recognized as white by the human in each of the subframes included in one frame, even when the color rotation frequency is 60 Hz, color breakup can be reduced. That is, according to the first embodiment, both color gamut and the brightness can be achieved while reducing color breakup.

In the first embodiment, One frame includes a first subframe SF1, a second subframe SF2, and a third subframe SF3.

In the first subframe SF1, in the first liquid crystal panel 60, voltage corresponding to the first color data (in the present embodiment, the red data) is written to the pixels belonging to one or a plurality of lines (in the present embodiment, the first line) included in the first group, in the first liquid crystal panel 60, voltage corresponding to the second color data (in the present embodiment, the green data), which is different from the first color data, is written to the pixels belonging to one or a plurality of lines (in the present embodiment, the second line) included in the second group, and in the first liquid crystal panel 60, voltage corresponding to the third color data (in the present embodiment, the blue data), which is different from the first color data and from the second color data, is written to the pixels belonging to one or a plurality of lines (in the present embodiment, the third line) included in the third group.

In the second subframe SF2, in the first liquid crystal panel 60, voltage corresponding to the second color data (in the present embodiment, the green data) is written to the pixels belonging to one or a plurality of lines (in the present embodiment, the first line) included in the first group, in the first liquid crystal panel 60, voltage corresponding to the third color data (in the present embodiment, the blue data) is written to the pixels belonging to one or a plurality of lines (in the present embodiment, the second line) included in the second group, and in the first liquid crystal panel 60, voltage corresponding to the first color data (in the present embodiment, the red data) is written to the pixels belonging to one or a plurality of lines (in the present embodiment, the third line) included in the third group.

In the third subframe SF3, in the first liquid crystal panel 60, voltage corresponding to the third color data (in the present embodiment, the blue data) is written to the pixels belonging to one or a plurality of lines (the first line in the present embodiment) included in the first group, in the first liquid crystal panel 60, voltage corresponding to the first color data (in the present embodiment, the red data) is written to the pixels belonging to one or a plurality of lines (the second line in the present embodiment) included in the second group, and in the first liquid crystal panel 60, voltage corresponding to the second color data (in the present embodiment, the green data) is written to the pixels belonging to one or a plurality of lines (the third line in the present embodiment) included in the third group. Each of the first color data, the second color data, and the third color data is any one of the red data, the green data, and the blue data.

According to the first embodiment as described above, in one frame including three subframes, the colors of the first image light IL1 are recognized by humans in the order of white, white, and white, and thus, even when the color rotation frequency is 60 Hz, both color gamut and brightness can be achieved while reducing color breakup.

In the first embodiment, each of the plurality of subframes includes the odd-numbered field, which is a first half period, and the even-numbered field, which is a second half period. In the odd-numbered field, in the first liquid crystal panel 60, voltage corresponding to different color data from one another for each one or a plurality of lines and having the first polarity (positive polarity in the present embodiment) are written, and the emission of the first color light L1 from the first light source device 20 is stopped. In the even-numbered field, in the first liquid crystal panel 60, voltage corresponding to different color data from one another for each one or a plurality of lines and having the second polarity (negative polarity in the present embodiment) opposite to the first polarity are written, and the first color light L1 incident on the first liquid crystal panel 60 is scanned from the first line toward the last line.

According to the first embodiment described above, since the first light source device 20 emits the first color light L1 in the even-numbered fields included in each subframe, that is, only in the period in which the voltage of the second polarity is written, the occurrence of crosstalk in the projection image can be suppressed.

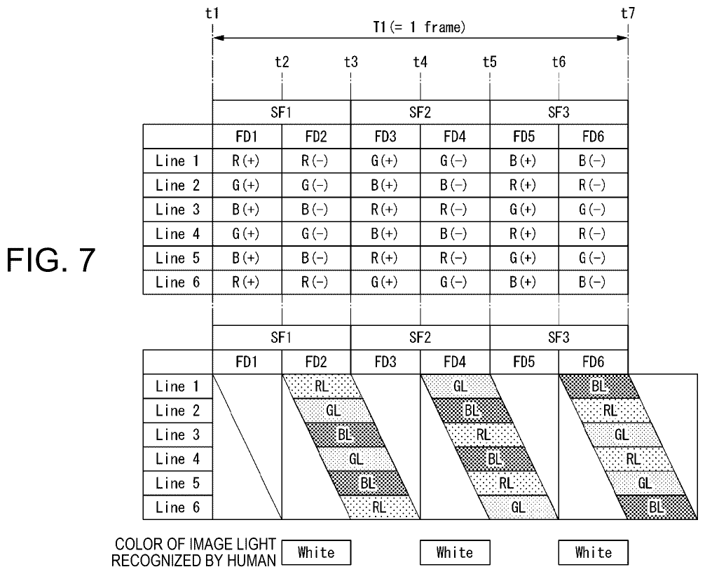

Note that in the first embodiment, in the first subframe SF1, the voltages are written in the order of the red data, green data, and blue data from the first line toward the third line, and the voltages are written in the same order from the fourth line toward the sixth line. In the second subframe SF2, the voltages are written in the order of the green data, the blue data, and the red data from the first line toward the third line, and the voltages are written in the same order from the fourth line toward the sixth line. In the third subframe SF3, the voltages are written in the order of the blue data, the red data, and the green data from the first line toward the third line, and the voltages are written in the same order from the fourth line toward the sixth line. However, the order in which the voltages are written is not limited to the above order. For example, as shown in FIG. 7, the order in which the voltages of the first line to the third line are written may be different from the order in which the voltages of the fourth line to the sixth line are written.

FIG. 7 is a timing chart showing a modification of the operation of the projector 201 according to the first embodiment. As shown in FIG. 7, in the first subframe SF1, the voltages may be written in the order of the red data, the green data, and the blue data from the first line toward the third line, and the voltages may be written in the order of the green data, the blue data, and the red data from the fourth line toward the sixth line. In the second subframe SF2, the voltages may be written in the order of the green data, the blue data, and the red data from the first line toward the third line, and the voltages may be written in the order of the blue data, the red data, and the green data from the fourth line toward the sixth line. In the third subframe SF3, the voltages may be written in the order of the blue data, the red data, and the green data from the first line toward the third line, and the voltages may be written in the order of the red data, the green data, and the blue data from the fourth line toward the sixth line.

Also in the modification example shown in FIG. 7, the first image light IL1 projected in the second field FD2 is recognized by the human as white image light due to the integration effect of the eyes. The first image light IL1 projected in the fourth field FD4 is also recognized by the human as white image light, and the first image light IL1 projected in the sixth field FD6 is also recognized by the human as white image light. As a result, the first image light IL1 projected in one frame is recognized by the human as a full-color image light.

### Second Embodiment

Next, the second embodiment of the present disclosure will be described. In the description of the second embodiment, the description of the contents common to the first embodiment will be omitted, and only the contents different from the first embodiment will be described. The configuration of the projector according to the second embodiment is the same as the configuration of the projector 201 according to the first embodiment. Therefore, in the following description, the projector according to the second embodiment is also referred to as the projector 201.

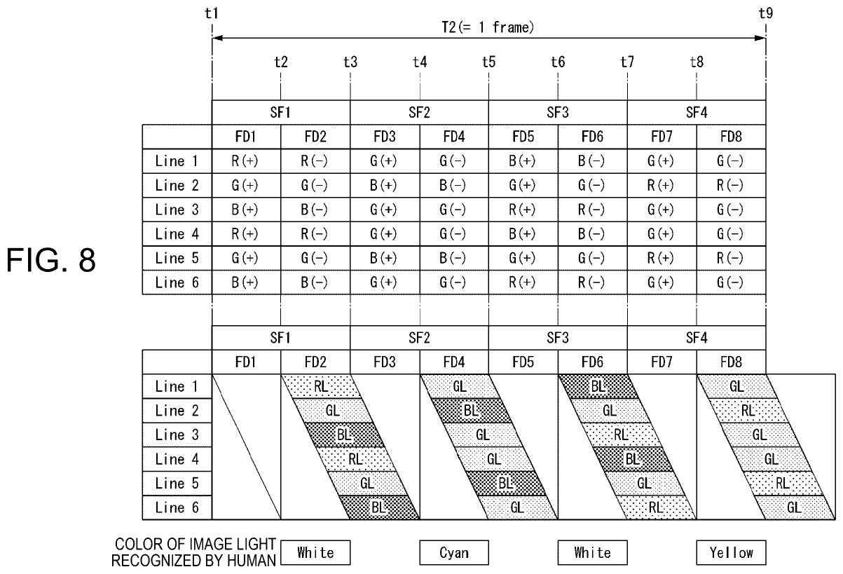

The operation of the projector 201 according to the second embodiment will be described below with reference to FIG. 8. FIG. 8 is a timing chart showing the operation of the projector 201 according to the second embodiment.

In FIG. 8, a period T2 from a time t1 to a time t9 corresponds to one frame. In the second embodiment, one frame is equally divided into four subframes. One frame includes a first subframe SF1, a second subframe SF2, a third subframe SF3, and a fourth subframe SF4. In FIG. 7, a period from the time t1 to the time t3 corresponds to the first subframe SF1, a period from the time t3 to the time t5 corresponds to the second subframe SF2, a period from the time t5 to the time t7 corresponds to the third subframe SF3, and a period from the time t7 to the time t9 corresponds to the fourth subframe SF4.

As in the first embodiment, in the second embodiment, each subframe is divided equally into two fields. The first subframe SF1 includes a first field FD1 that is a first half period of the first subframe SF1 and a second field FD2 that is a second half period of the first subframe SF1. The second subframe SF2 includes a third field FD3 that is a first half period of the second subframe SF2 and a fourth field FD4 that is a second half period of the second subframe SF2. The third subframe SF3 includes a fifth field FD5 that is a first half period of the third subframe SF3 and a sixth field FD6 that is a second half period of the third subframe SF3. The fourth subframe SF4 includes a seventh field FD7 that is a first half period of the fourth subframe SF4 and an eighth field FD8 that is a second half period of the fourth subframe SF4.

In FIG. 8, a period from the time t1 to the time t2 corresponds to the first field FD1, and a period from the time t2 to the time t3 corresponds to the second field FD2. The period from the time t3 to the time t4 corresponds to the third field FD3, and the period from the time t4 to the time t5 corresponds to the fourth field FD4. The period from the time t5 to the time t6 corresponds to the fifth field FD5, and the period from the time t6 to the time t7 corresponds to the sixth field FD6. The period from the time t7 to the time t8 corresponds to the seventh field FD7, and the period from the time t8 to the time t9 corresponds to the eighth field FD8.

As in the first embodiment, in the second embodiment, the odd-numbered fields including the first field FD1, the third field FD3, the fifth field FD5, and the seventh field FD7 is a period in which voltage having a positive polarity is written to each line in order from the first line to the last line in the first liquid crystal panel 60. The even-numbered fields including the second field FD2, the fourth field FD4, the sixth field FD6, and the eighth field FD8 is a period in which voltage having a negative polarity is written to each line in order from the first line toward the last line in the first liquid crystal panel 60.

For example, the frame rate in the second embodiment is 60 fps. That is, one frame corresponding to the period T2 from the time t1 to the time t9 is about 16. 7 ms. In this case, the period of one field is about 2. 09 ms. That is, in the second embodiment, the drive frequency of the first liquid crystal panel 60 is about 480 Hz.

As in the first embodiment, in the second embodiment, for convenience of description, it is assumed that the first liquid crystal panel 60 has six lines. In FIG. 8, “Line 1” represents the first line from the +Y side. “Line 2” represents the second line from the +Y side. “Line 3” represents the third line from the +Y side. “Line 4” represents the fourth line from the +Y side. “Line 5” represents the fifth line from the +Y side. “Line 6” represents the sixth line from the +Y side.

As shown in the timing chart in the upper part of FIG. 8, in the first field FD1, a voltage (“R (+)”) corresponding to the red data and having a positive polarity is written to the first line. In the first field FD1, a voltage (“G (+)”) corresponding to the green data and having a positive polarity is written to the second line. In the first field FD1, a voltage (“B (+)”) corresponding to the blue data and having a positive polarity is written to the third line.

In the first field FD1, a voltage (“R (+)”) corresponding to the red data and having a positive polarity is written to the fourth line. In the first field FD1, a voltage (“G (+)”) corresponding to the green data and having a positive polarity is written to the fifth line. In the first field FD1, a voltage (“B (+)”) corresponding to the blue data and having a positive polarity is written to the sixth line.

In the second field FD2, a voltage (“R (−)”) corresponding to the red data and having a negative polarity is written to the first line. In the second field FD2, a voltage (“G (−)”) corresponding to the green data and having a negative polarity is written to the second line. In the second field FD2, a voltage (“B (−)”) corresponding to the blue data and having a negative polarity is written to the third line.

In the second field FD2, a voltage (“R (−)”) corresponding to the red data and having a negative polarity is written to the fourth line. In the second field FD2, a voltage (“G (−)”) corresponding to the green data and having a negative polarity is written to the fifth line. In the second field FD2, a voltage (“B (−)”) corresponding to the blue data and having a negative polarity is written to the sixth line.

In the third field FD3, a voltage (“G (+)”) corresponding to the green data and having a positive polarity is written to the first line. In the third field FD3, a voltage (“B (+)”) corresponding to the blue data and having a positive polarity is written to the second line. In the third field FD3, a voltage (“G (+)”) corresponding to the green data and having a positive polarity is written to the third line.

In the third field FD3, a voltage (“G (+)”) corresponding to the green data and having a positive polarity is written to the fourth line. In the third field FD3, a voltage (“B (+)”) corresponding to the blue data and having a positive polarity is written to the fifth line. In the third field FD3, a voltage (“G (+)”) corresponding to the green data and having a positive polarity is written to the sixth line.

In the fourth field FD4, a voltage (“G (−)”) corresponding to the green data and having a negative polarity is written to the first line. In the fourth field FD4, a voltage (“B (−)”) corresponding to the blue data and having a negative polarity is written to the second line. In the fourth field FD4, a voltage (“G (−)”) corresponding to the green data and having a negative polarity is written to the third line.

In the fourth field FD4, a voltage (“G (−)”) corresponding to the green data and having a negative polarity is written to the fourth line. In the fourth field FD4, a voltage (“B (−)”) corresponding to the blue data and having a negative polarity is written to the fifth line. In the fourth field FD4, a voltage (“G (−)”) corresponding to the green data and having a negative polarity is written to the sixth line.

In the fifth field FD5, a voltage (“B (+)”) corresponding to the blue data and having a positive polarity is written to the first line. In the fifth field FD5, a voltage (“G (+)”) corresponding to the green data and having a positive polarity is written to the second line. In the fifth field FD5, a voltage (“R (+)”) corresponding to the red data and having a positive polarity is written to the third line.

In the fifth field FD5, a voltage (“B (+)”) corresponding to the blue data and having a positive polarity is written to the fourth line. In the fifth field FD5, a voltage (“G (+)”) corresponding to the green data and having a positive polarity is written to the fifth line. In the fifth field FD5, a voltage (“R (+)”) corresponding to the red data and having a positive polarity is written to the sixth line.

In the sixth field FD6, a voltage (“B (−)”) corresponding to the blue data and having a negative polarity is written to the first line. In the sixth field FD6, a voltage (“G (−)”) corresponding to the green data and having a negative polarity is written to the second line. In the sixth field FD6, a voltage (“R (−)”) corresponding to the red data and having a negative polarity is written to the third line.

In the sixth field FD6, a voltage (“B (−)”) corresponding to the blue data and having a negative polarity is written to the fourth line. In the sixth field FD6, a voltage (“G (−)”) corresponding to the green data and having a negative polarity is written to the fifth line. In the sixth field FD6, a voltage (“R (−)”) corresponding to the red data and having a negative polarity is written to the sixth line.

In the seventh field FD7, a voltage (“G (+)”) corresponding to the green data and having a positive polarity is written to the first line. In the seventh field FD7, a voltage (“R (+)”) corresponding to the red data and having a positive polarity is written to the second line. In the seventh field FD7, a voltage (“G (+)”) corresponding to the green data and having a positive polarity is written to the third line.

In the seventh field FD7, a voltage (“G (+)”) corresponding to the green data and having a positive polarity is written to the fourth line. In the seventh field FD7, a voltage (“R (+)”) corresponding to the red data and having a positive polarity is written to the fifth line. In the seventh field FD7, a voltage (“G (+)”) corresponding to the green data and having a positive polarity is written to the sixth line.

In the eighth field FD8, a voltage (“G (−)”) corresponding to the green data and having a negative polarity is written to the first line. In the eighth field FD8, a voltage (“R (−)”) corresponding to the red data and having a negative polarity is written to the second line. In the eighth field FD8, a voltage (“G (−)”) corresponding to the green data and having a negative polarity is written to the third line.

In the eighth field FD8, a voltage (“G (−)”) corresponding to the green data and having a negative polarity is written to the fourth line. In the eighth field FD8, a voltage (“R (−)”) corresponding to the red data and having a negative polarity is written to the fifth line. In the eighth field FD8, a voltage (“G (−)”) corresponding to the green data and having a negative polarity is written to the sixth line.

As shown in the timing chart in the lower part of FIG. 8, in the second embodiment, in each of the four subframes, the first color light L1 incident on the first liquid crystal panel 60 is scanned from the first line to the sixth line. As in the first embodiment, in the second embodiment, the emission of the first color light L1 from the first light source device 20 is stopped in the odd-numbered fields. In the even-numbered fields, the first color light L1 incident on the first liquid crystal panel 60 is scanned from the first line toward the sixth line.

Specifically, in the second field FD2, the red light RL is irradiated to the first line in a period in which the “R (−)” voltage is written to the first line, the green light GL is irradiated to the second line in a period in which the “G (−)” voltage is written to the second line, and the blue light BL is irradiated to the third line in a period in which the “B (−)” voltage is written to the third line.

In the second field FD2, the red light RL is irradiated to the forth line in a period in which the “R (−)” voltage is written to the fourth line, the green light GL is irradiated to the fifth line in a period in which the “G (−)” voltage is written to the fifth line, and the blue light BL is irradiated to the sixth line in a period in which the “B (−)” voltage is written to the sixth line.

In the second field FD2, since the timing at which the “G (−)” voltage starts to be written to the second line is later than the timing at which the “R (−)” voltage starts to be written to the first line, the timing at which the green light GL starts to be irradiated to the second line is later than the timing at which the red light RL starts to be irradiated to the first line. Since the timing at which the “B (−)” voltage starts to be written in the third line is later than the timing at which the “G (−)” voltage starts to be written in the second line, the timing at which the blue light BL starts to be irradiated on the third line is later than the timing at which the green light GL starts to be irradiated on the second line. The same applies to the case where the first color light L1 is irradiated to the fourth line to the sixth line in the second field FD2.

In the fourth field FD4, the green light GL is irradiated to the first line in a period in which the “G (−)” voltage is written to the first line, the blue light BL is irradiated to the second line in a period in which the “B (−)” voltage is written to the second line, and the green light GL is irradiated to the third line in a period in which the “G (−)” voltage is written to the third line.

In the fourth field FD4, the green light GL is irradiated to the fourth line in a period in which the “G (−)” voltage is written to the fourth line, the blue light BL is irradiated to the fifth line in a period in which the “B (−)” voltage is written to the fifth line, and the sixth line is irradiated with the green light GL in a period in which the “G (−)” voltage is written to the sixth line.

In the fourth field FD4, since the timing at which the “B (−)” voltage starts to be written to the second line is later than the timing at which the “G (−)” voltage starts to be written to the first line, the timing at which the blue light BL starts to be irradiated to the second line is later than the timing at which the green light GL starts to be irradiated to the first line. Since the timing at which the “G (−)” voltage starts to be written in the third line is later than the timing at which the “B (−)” voltage starts to be written in the second line, the timing at which the green light GL starts to be irradiated on the third line is later than the timing at which the blue light BL starts to be irradiated on the second line. The same applies to the case where the first color light L1 is irradiated to the fourth line to the sixth line in the fourth field FD4.

In the sixth field FD6, the blue light BL is irradiated to the first line in a period in which the “B (−)” voltage is written to the first line, the green light GL is irradiated to the second line in a period in which the “G (−)” voltage is written to the second line, and the red light RL is irradiated to the third line in a period in which the “R (−)” voltage is written to the third line.

In the sixth field FD6, the blue light BL is irradiated to the fourth line in a period in which the “B (−)” voltage is written to the fourth line, the green light GL is irradiated to the fifth line in a period in which the “G (−)” voltage is written to the fifth line, and the red light RL is irradiated to the sixth line in a period in which the “R (−)” voltage is written to the sixth line.

In the sixth field FD6, since the timing at which the “G (−)” voltage starts to be written to the second line is later than the timing at which the “B (−)” voltage starts to be written to the first line, the timing at which the green light GL starts to be irradiated to the second line is later than the timing at which the blue light BL starts to be irradiated to the first line. Since the timing at which the “R (−)” voltage starts to be written to the third line is later than the timing at which the “G (−)” voltage starts to be written to the second line, the timing at which the red light RL starts to be irradiated to the third line is later than the timing at which the green light GL starts to be irradiated to the second line. The same applies to the case where the first color light L1 is irradiated to the fourth line to the sixth line in the sixth field FD6.

In the eighth field FD8, the green light GL is irradiated to the first line in a period in which the “G (−)” voltage is written to the first line, the red light RL is irradiated to the second line in a period in which the “R (−)” voltage is written to the second line, and the green light GL is irradiated to the third line in a period in which the “G (−)” voltage is written to the third line.

In the eighth field FD8, the green light GL is irradiated to the fourth line in a period in which the “G (−)” voltage is written to the fourth line, the red light RL is irradiated to the fifth line in a period in which the “R (−)” voltage is written to the fifth line, and the green light GL is irradiated to the sixth line in a period in which the “G (−)” voltage is written to the sixth line.

In the eighth field FD8, since the timing at which the “R (−)” voltage starts to be written to the second line is later than the timing at which the “G (−)” voltage starts to be written to the first line, the timing at which the red light RL starts to be irradiated to the second line is later than the timing at which the green light GL starts to be irradiated to the first line. Since the timing at which the “G (−)” voltage starts to be written in the third line is later than the timing at which the “R (−)” voltage starts to be written in the second line, the timing at which the green light GL starts to be irradiated on the third line is later than the timing at which the red light RL starts to be irradiated on the second line. The same applies to the case where the first color light L1 is irradiated to the fourth line to the sixth line in the eighth field FD8.

According to the operation of the second embodiment as described above, the first image light IL1 projected in the second field FD2 is recognized by the human as white image light due to the integration effect of the eyes. The first image light IL1 projected in the fourth field FD4 is recognized by the human as cyan image light. The first image light IL1 projected in the sixth field FD6 is recognized by the human as white image light. The first image light IL1 projected in the eighth field FD8 is recognized by the human as yellow image light. As a result, the first image light IL1 projected in one frame is recognized by the human as a full-color image light.

According to the operation of the second embodiment, in one frame, the color of the first image light IL1 is recognized by the human in the order of white, cyan (complementary color), white, and yellow (complementary color). As described above, in the second embodiment, since complementary colors are mixed in the colors recognized by the human in one frame, the effect of reducing color breakup is lower than that in the first embodiment. However, in the second embodiment, since the light emission period of green in one frame is longer than that in the first embodiment, the brightness of the image recognized by the human can be improved.

As described above, in the second embodiment, one frame includes the first subframe SF1, the second subframe SF2, the third subframe SF3, and the fourth subframe SF4.

In the first subframe SF1, in the first liquid crystal panel 60, voltage corresponding to the first color data (in the present embodiment, the red data) is written to the pixels belonging to one or a plurality of lines (in the present embodiment, the first line) included in the first group, in the first liquid crystal panel 60, voltage corresponding to the second color data (in the present embodiment, the green data), which is different from the first color data, is written to the pixels belonging to one or a plurality of lines (in the present embodiment, the second line) included in the second group, and in the first liquid crystal panel 60, voltage corresponding to the third color data (in the present embodiment, the blue data), which is different from the first color data, and the second color data is written to the pixels belonging to one or a plurality of lines (in the present embodiment, the third line) included in the third group.

In the second subframe SF2, in the first liquid crystal panel 60, voltage corresponding to the second color data (in the present embodiment, the green data) is written to the pixels belonging to one or a plurality of lines (in the present embodiment, the first line) included in the first group, in the first liquid crystal panel 60, voltage corresponding to the third color data (in the present embodiment, the blue data) is written to the pixels belonging to one or a plurality of lines (in the present embodiment, the second line) included in the second group, and in the first liquid crystal panel 60, voltage corresponding to the second color data (in the present embodiment, the green data) is written to the pixels belonging to one or a plurality of lines (the third line in the present embodiment) included in the third group.

In the third subframe SF3, in the first liquid crystal panel 60, voltage corresponding to the third color data (in the present embodiment, the blue data) is written to the pixels belonging to one or a plurality of lines (the first line in the present embodiment) included in the first group, in the first liquid crystal panel 60, voltage corresponding to the second color data (in the present embodiment, the green data) is written to the pixels belonging to one or a plurality of lines (in the present embodiment, the second line) included in the second group, and in the first liquid crystal panel 60, voltage corresponding to the first color data (in the present embodiment, the red data) is written to the pixels belonging to one or a plurality of lines (in the present embodiment, the third line) included in the third group.

In the fourth subframe SF4, in the first liquid crystal panel 60, voltage corresponding to the second color data (in the present embodiment, the green data) is written to the pixels belonging to one or a plurality of lines (in the present embodiment, the first line) included in the first group, in the first liquid crystal panel 60, voltage corresponding to the first color data (in the present embodiment, the red data) is written to the pixels belonging to one or a plurality of lines (the second line in the present embodiment) included in the second group, and in the first liquid crystal panel 60, voltage corresponding to the second color data (in the present embodiment, the green data) is written to the pixels belonging to one or a plurality of lines (the third line in the present embodiment) included in the third group.

Each of the first color data, the second color data, and the third color data is any one of the red data, the green data, and the blue data.

In each subframe, the first liquid crystal panel 60 is scanned with the first color light L1 incident thereon from the first line toward the last line, the first light source device 20 emits the red light RL as the first color light L1 in a period in which voltage corresponding to the red data is written in the first liquid crystal panel 60, the first light source device 20 emits the green light GL as the first color light L1 in a period in which voltage corresponding to the green data is written in the first liquid crystal panel 60, and the first light source device 20 emits the blue light BL as the first color light L1 in a period in which voltage corresponding to the blue data is written in the first liquid crystal panel 60.

According to the second embodiment described above, in one frame, the color of the first image light IL1 is recognized by the human in the order of white, cyan (complementary color), white, and yellow (complementary color). As described above, in the second embodiment, since complementary colors are mixed in the colors recognized by the human in one frame, the effect of reducing color breakup is lower than that in the first embodiment. However, in the second embodiment, since the light emission period of green in one frame is longer than that in the first embodiment, the brightness of the image recognized by the human can be improved.

As described in the modification of the first embodiment, also in the second embodiment, the order in which voltages are written from the first line toward the sixth line is not limited to the order shown in FIG. 8.

### Third Embodiment

Next, the third embodiment of the present disclosure will be described. In the description of the third embodiment, the description of the contents common to the second embodiment will be omitted, and only the contents different from the second embodiment will be described. The configuration of the projector according to the third embodiment is the same as the configuration of the projector 201 according to the first embodiment. Therefore, in the following description, the projector according to the third embodiment is also referred to as the projector 201.

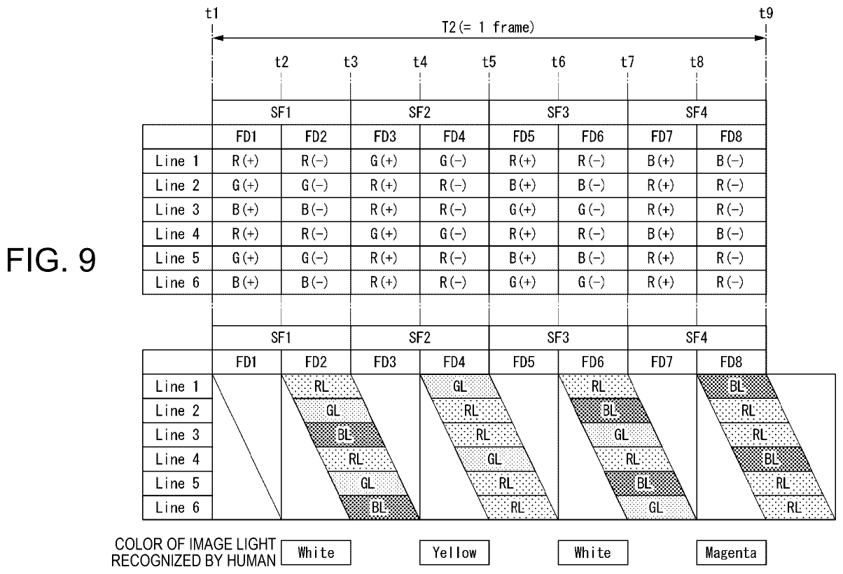

The operation of the projector 201 according to the third embodiment will be described below with reference to FIG. 9. FIG. 9 is a timing chart showing the operation of the projector 201 according to the third embodiment.

In FIG. 9, a period T2 from a time t1 to time t9 corresponds to one frame. As in the second embodiment, in the third embodiment, one frame is equally divided into four subframes. One frame includes a first subframe SF1, a second subframe SF2, a third subframe SF3, and a fourth subframe SF4.

As in the second embodiment, in the third embodiment, each subframe is equally divided into two fields. The first subframe SF1 includes the first field FD1 and the second field FD2. The second subframe SF2 includes the third field FD3 and the fourth field FD4. The third subframe SF3 includes the fifth field FD5 and the sixth field FD6. The fourth subframe SF4 includes the seventh field FD7 and the eighth field FD8.

As in the second embodiment, in the third embodiment, the odd-numbered fields including the first field FD1, the third field FD3, the fifth field FD5, and the seventh field FD7 is a period in which voltage having a positive polarity is written to each line in order from the first line to the last line in the first liquid crystal panel 60. The even-numbered fields including the second field FD2, the fourth field FD4, the sixth field FD6, and the eighth field FD8 is a period in which voltage having a negative polarity is written to each line in order from the first line toward the last line in the first liquid crystal panel 60.

For example, the frame rate in the third embodiment is 60 fps. That is, one frame corresponding to the period T2 from the time t1 to the time t9 is about 16. 7 ms. In this case, the period of one field is about 2. 09 ms. That is, in the third embodiment, the drive frequency of the first liquid crystal panel 60 is about 480 Hz.

As in the second embodiment, in the third embodiment, for convenience of description, it is assumed that the first liquid crystal panel 60 has six lines. In FIG. 9, “Line 1” represents the first line from the +Y side. “Line 2” represents the second line from the +Y side. “Line 3” represents the third line from the +Y side. “Line 4” represents the fourth line from the +Y side. “Line 5” represents the fifth line from the +Y side. “Line 6” represents the sixth line from the +Y side.

As shown in the timing chart in the upper part of FIG. 9, in the first field FD1, a voltage (“R (+)”) corresponding to the red data and having a positive polarity is written to the first line. In the first field FD1, a voltage (“G (+)”) corresponding to the green data and having a positive polarity is written to the second line. In the first field FD1, a voltage (“B (+)”) corresponding to the blue data and having a positive polarity is written to the third line.

In the first field FD1, a voltage (“R (+)”) corresponding to the red data and having a positive polarity is written to the fourth line. In the first field FD1, a voltage (“G (+)”) corresponding to the green data and having a positive polarity is written to the fifth line. In the first field FD1, a voltage (“B (+)”) corresponding to the blue data and having a positive polarity is written to the sixth line.

In the second field FD2, a voltage (“R (−)”) corresponding to the red data and having a negative polarity is written to the first line. In the second field FD2, a voltage (“G (−)”) corresponding to the green data and having a negative polarity is written to the second line. In the second field FD2, a voltage (“B (−)”) corresponding to the blue data and having a negative polarity is written to the third line.

In the second field FD2, a voltage (“R (−)”) corresponding to the red data and having a negative polarity is written to the fourth line. In the second field FD2, a voltage (“G (−)”) corresponding to the green data and having a negative polarity is written to the fifth line. In the second field FD2, a voltage (“B (−)”) corresponding to the blue data and having a negative polarity is written to the sixth line.

In the third field FD3, a voltage (“G (+)”) corresponding to the green data and having a positive polarity is written to the first line. In the third field FD3, a voltage (“R (+)”) corresponding to the red data and having a positive polarity is written to the second line. In the third field FD3, a voltage (“R (+)”) corresponding to the red data and having a positive polarity is written to the third line.

In the third field FD3, a voltage (“G (+)”) corresponding to the green data and having a positive polarity is written to the fourth line. In the third field FD3, a voltage (“R (+)”) corresponding to the red data and having a positive polarity is written to the fifth line. In the third field FD3, a voltage (“R (+)”) corresponding to the red data and having a positive polarity is written to the sixth line.

In the fourth field FD4, a voltage (“G (−)”) corresponding to the green data and having a negative polarity is written to the first line. In the fourth field FD4, a voltage (“R (−)”) corresponding to the red data and having a negative polarity is written to the second line. In the fourth field FD4, a voltage (“R (−)”) corresponding to the red data and having a negative polarity is written to the third line.

In the fourth field FD4, a voltage (“G (−)”) corresponding to the green data and having a negative polarity is written to the fourth line. In the fourth field FD4, a voltage (“R (−)”) corresponding to the red data and having a negative polarity is written to the fifth line. In the fourth field FD4, a voltage (“R (−)”) corresponding to the red data and having a negative polarity is written to the sixth line.

In the fifth field FD5, a voltage (“R (+)”) corresponding to the red data and having a positive polarity is written to the first line. In the fifth field FD5, a voltage (“B (+)”) corresponding to the blue data and having a positive polarity is written to the second line. In the fifth field FD5, a voltage (“G (+)”) corresponding to the green data and having a positive polarity is written to the third line.

In the fifth field FD5, a voltage (“R (+)”) corresponding to the red data and having a positive polarity is written to the fourth line. In the fifth field FD5, a voltage (“B (+)”) corresponding to the blue data and having a positive polarity is written to the fifth line. In the fifth field FD5, a voltage (“G (+)”) corresponding to the green data and having a positive polarity is written to the sixth line.

In the sixth field FD6, a voltage (“R (−)”) corresponding to the red data and having a negative polarity is written to the first line. In the sixth field FD6, a voltage (“B (−)”) corresponding to the blue data and having a negative polarity is written to the second line. In the sixth field FD6, a voltage (“G (−)”) corresponding to the green data and having a negative polarity is written to the third line.

In the sixth field FD6, a voltage (“R (−)”) corresponding to the red data and having a negative polarity is written to the fourth line. In the sixth field FD6, a voltage (“B (−)”) corresponding to the blue data and having a negative polarity is written to the fifth line. In the sixth field FD6, a voltage (“G (−)”) corresponding to the green data and having a negative polarity is written to the sixth line.

In the seventh field FD7, a voltage (“B (+)”) corresponding to the blue data and having a positive polarity is written to the first line. In the seventh field FD7, a voltage (“R (+)”) corresponding to the red data and having a positive polarity is written to the second line. In the seventh field FD7, a voltage (“R (+)”) corresponding to the red data and having a positive polarity is written to the third line.

In the seventh field FD7, a voltage (“B (+)”) corresponding to the blue data and having a positive polarity is written to the fourth line. In the seventh field FD7, a voltage (“R (+)”) corresponding to the red data and having a positive polarity is written to the fifth line. In the seventh field FD7, a voltage (“R (+)”) corresponding to the red data and having a positive polarity is written to the sixth line.

In the eighth field FD8, a voltage (“B (−)”) corresponding to the blue data and having a negative polarity is written to the first line. In the eighth field FD8, a voltage (“R (−)”) corresponding to the red data and having a negative polarity is written to the second line. In the eighth field FD8, a voltage (“R (−)”) corresponding to the red data and having a negative polarity is written to the third line.

In the eighth field FD8, a voltage (“B (−)”) corresponding to the blue data and having a negative polarity is written to the fourth line. In the eighth field FD8, a voltage (“R (−)”) corresponding to the red data and having a negative polarity is written to the fifth line. In the eighth field FD8, a voltage (“R (−)”) corresponding to the red data and having a negative polarity is written to the sixth line.

As shown in the timing chart in the lower part of FIG. 9, in the third embodiment, in each of the four subframes, the first color light L1 incident on the first liquid crystal panel 60 is scanned from the first line toward the sixth line. As in the second embodiment, in the third embodiment, the emission of the first color light L1 from the first light source device 20 is stopped in the odd-numbered field. In the even-numbered fields, the first color light L1 incident on the first liquid crystal panel 60 is scanned from the first line toward the sixth line.

Specifically, in the second field FD2, the red light RL is irradiated to the first line in a period in which the “R (−)” voltage is written to the first line, the green light GL is irradiated to the second line in a period in which the “G (−)” voltage is written to the second line, and the blue light BL is irradiated to the third line in a period in which the “B (−)” voltage is written to the third line.

In the second field FD2, the red light RL is irradiated to the forth line in a period in which the “R (−)” voltage is written to the fourth line, the green light GL is irradiated to the fifth line in a period in which the “G (−)” voltage is written to the fifth line, and the blue light BL is irradiated to the sixth line in a period in which the “B (−)” voltage is written to the sixth line.

In the second field FD2, since the timing at which the “G (−)” voltage starts to be written to the second line is later than the timing at which the “R (−)” voltage starts to be written to the first line, the timing at which the green light GL starts to be irradiated to the second line is later than the timing at which the red light RL starts to be irradiated to the first line. Since the timing at which the “B (−)” voltage starts to be written in the third line is later than the timing at which the “G (−)” voltage starts to be written in the second line, the timing at which the blue light BL starts to be irradiated on the third line is later than the timing at which the green light GL starts to be irradiated on the second line. The same applies to the case where the first color light L1 is irradiated to the fourth line to the sixth line in the second field FD2.

In the fourth field FD4, the green light GL is irradiated to the first line in a period in which the “G (−)” voltage is written to the first line, the red light RL is irradiated to the second line in a period in which the “R (−)” voltage is written to the second line, and the red light RL is irradiated to the third line in a period in which the “R (−)” voltage is written to the third line.

In the fourth field FD4, the green light GL is irradiated to the fourth line in a period in which the “G (−)” voltage is written to the fourth line, the red light RL is irradiated to the fifth line in a period in which the “R (−)” voltage is written to the fifth line, and the red light RL is irradiated to the sixth line in a period in which the “R (−)” voltage is written to the sixth line.

In the fourth field FD4, since the timing at which the “R (−)” voltage starts to be written to the second line is later than the timing at which the “G (−)” voltage starts to be written to the first line, the timing at which the red light RL starts to be irradiated to the second line is later than the timing at which the green light GL starts to be irradiated to the first line. Since the timing at which the “R (−)” voltage starts to be written to the third line is later than the timing at which the “R (−)” voltage starts to be written to the second line, the timing at which the red light RL starts to be irradiated to the third line is later than the timing at which the red light RL starts to be irradiated to the second line. The same applies to the case where the first color light L1 is irradiated to the fourth line to the sixth line in the fourth field FD4.

In the sixth field FD6, the red light RL is irradiated to the first line in a period in which the “R (−)” voltage is written to the first line, the blue light BL is irradiated to the second line in a period in which the “B (−)” voltage is written to the second line, and the green light GL is irradiated to the third line in a period in which the “G (−)” voltage is written to the third line.

In the sixth field FD6, the red light RL is irradiated to the fourth line in a period in which the “R (−)” voltage is written to the fourth line, the blue light BL is irradiated to the fifth line in a period in which the “B (−)” voltage is written to the fifth line, and the green light GL is irradiated to the sixth line in a period in which the “G (−)” voltage is written to the sixth line.

In the sixth field FD6, since the timing at which the “B (−)” voltage starts to be written to the second line is later than the timing at which the “R (−)” voltage starts to be written to the first line, the timing at which the blue light BL starts to be irradiated to the second line is later than the timing at which the red light RL starts to be irradiated to the first line. Since the timing at which the “G (−)” voltage starts to be written in the third line is later than the timing at which the “B (−)” voltage starts to be written in the second line, the timing at which the green light GL starts to be irradiated on the third line is later than the timing at which the blue light BL starts to be irradiated on the second line. The same applies to the case where the first color light L1 is irradiated to the fourth line to the sixth line in the sixth field FD6.

In the eighth field FD8, the blue light BL is irradiated to the first line in a period in which the “B (−)” voltage is written to the first line, the red light RL is irradiated to the second line in a period in which the “R (−)” voltage is written to the second line, and the red light RL is irradiated to the third line in a period in which the “R (−)” voltage is written to the third line.

In the eighth field FD8, the blue light BL is irradiated to the fourth line in a period in which the “B (−)” voltage is written to the fourth line, the red light RL is irradiated to the fifth line in a period in which the “R (−)” voltage is written to the fifth line, and the red light RL is irradiated to the sixth line in a period in which the “R (−)” voltage is written to the sixth line.

In the eighth field FD8, since the timing at which the “R (−)” voltage starts to be written to the second line is later than the timing at which the “B (−)” voltage starts to be written to the first line, the timing at which the red light RL starts to be irradiated to the second line is later than the timing at which the blue light BL starts to be irradiated to the first line. Since the timing at which the “R (−)” voltage starts to be written to the third line is later than the timing at which the “R (−)” voltage starts to be written to the second line, the timing at which the red light RL starts to be irradiated to the third line is later than the timing at which the red light RL starts to be irradiated to the second line. The same applies to the case where the first color light L1 is irradiated to the fourth line to the sixth line in the eighth field FD8.

According to the operation of the third embodiment as described above, the first image light IL1 projected in the second field FD2 is recognized by the human as white image light due to the integration effect of the eyes. The first image light IL1 projected in the fourth field FD4 is recognized by the human as yellow image light. The first image light IL1 projected in the sixth field FD6 is recognized by the human as white image light. The first image light IL1 projected in the eighth field FD8 is recognized by the human as magenta image light. As a result, the first image light IL1 projected in one frame is recognized by the human as a full-color image light.

According to the operation of the third embodiment, in one frame, the color of the first image light IL1 is recognized by the human in the order of white, yellow (complementary color), white, and magenta (complementary color). As described above, in the third embodiment, since the complementary colors are mixed in the colors recognized by the human in one frame, the effect of reducing color breakup is lower than that in the first embodiment. However, in the third embodiment, since the light emission period of red in one frame is longer than that in the first embodiment, the white balance of the image recognized by the human can be improved.

As described above, in the third embodiment, one frame includes the first subframe SF1, the second subframe SF2, the third subframe SF3, and the fourth subframe SF4.

In the first subframe SF1, in the first liquid crystal panel 60, voltage corresponding to the first color data (in the present embodiment, the red data) is written to the pixels belonging to one or a plurality of lines (in the present embodiment, the first line) included in the first group, in the first liquid crystal panel 60, voltage corresponding to the second color data (in the present embodiment, the green data), which is different from the first color data, is written to the pixels belonging to one or a plurality of lines (in the present embodiment, the second line) included in the second group, and in the first liquid crystal panel 60, voltage corresponding to the third color data (in the present embodiment, the blue data), which is different from the first color data, and the second color data is written to the pixels belonging to one or a plurality of lines (in the present embodiment, the third line) included in the third group.

In the second subframe SF2, in the first liquid crystal panel 60, voltage corresponding to the second color data (in the present embodiment, the green data) is written to the pixels belonging to one or a plurality of lines (in the present embodiment, the first line) included in the first group, in the first liquid crystal panel 60, voltage corresponding to the first color data (in the present embodiment, the red data) is written to the pixels belonging to one or a plurality of lines (the second line in the present embodiment) included in the second group, and in the first liquid crystal panel 60, voltage corresponding to the first color data (in the present embodiment, the red data) is written to the pixels belonging to one or a plurality of lines (in the present embodiment, the third line) included in the third group.

In the third subframe SF3, in the first liquid crystal panel 60, voltage corresponding to the first color data (in the present embodiment, the red data) is written to the pixels belonging to one or a plurality of lines (in the present embodiment, the first line) included in the first group, in the first liquid crystal panel 60, voltage corresponding to the third color data (in the present embodiment, the blue data) is written to the pixels belonging to one or a plurality of lines (in the present embodiment, the second line) included in the second group, and in the first liquid crystal panel 60, voltage corresponding to the second color data (in the present embodiment, the green data) is written to the pixels belonging to one or a plurality of lines (the third line in the present embodiment) included in the third group.

In the fourth subframe SF4, in the first liquid crystal panel 60, voltage corresponding to the third color data (in the present embodiment, the blue data) is written to the pixels belonging to one or a plurality of lines (the first line in the present embodiment) included in the first group, in the first liquid crystal panel 60, voltage corresponding to the first color data (in the present embodiment, the red data) is written to the pixels belonging to one or a plurality of lines (the second line in the present embodiment) included in the second group, and in the first liquid crystal panel 60, voltage corresponding to the first color data (in the present embodiment, the red data) is written to the pixels belonging to one or a plurality of lines (in the present embodiment, the third line) included in the third group.

Each of the first color data, the second color data, and the third color data is any one of the red data, the green data, and the blue data.

In each subframe, the first liquid crystal panel 60 is scanned with the first color light L1 incident thereon from the first line toward the last line, the first light source device 20 emits the red light RL as the first color light L1 in a period in which voltage corresponding to the red data is written in the first liquid crystal panel 60, the first light source device 20 emits the green light GL as the first color light L1 in a period in which voltage corresponding to the green data is written in the first liquid crystal panel 60, and the first light source device 20 emits the blue light BL as the first color light L1 in a period in which voltage corresponding to the blue data is written in the first liquid crystal panel 60.

According to the third embodiment described above, in one frame, the color of the first image light IL1 is recognized by the human in the order of white, yellow (complementary color), white, and magenta (complementary color). As described above, in the third embodiment, since the complementary colors are mixed in the colors recognized by the human in one frame, the effect of reducing color breakup is lower than that in the first embodiment. However, in the third embodiment, since the light emission period of red in one frame is longer than that in the first embodiment, the white balance of the image recognized by the human can be improved.

As described in the modification of the first embodiment, also in the third embodiment, the order in which voltages are written from the first line toward the sixth line is not limited to the order shown in FIG. 9.

### Fourth Embodiment

Next, a fourth embodiment of the present disclosure will be described. In the description of the fourth embodiment, the description of the contents common to the first embodiment will be omitted, and only the contents different from the first embodiment will be described. Further, regarding the configuration of a projector 202 according to the fourth embodiment, the same reference symbols as those of the corresponding configurations of the projector 201 according to the first embodiment are given to the configurations common to the projector 201 according to the first embodiment, and the description thereof will be omitted.

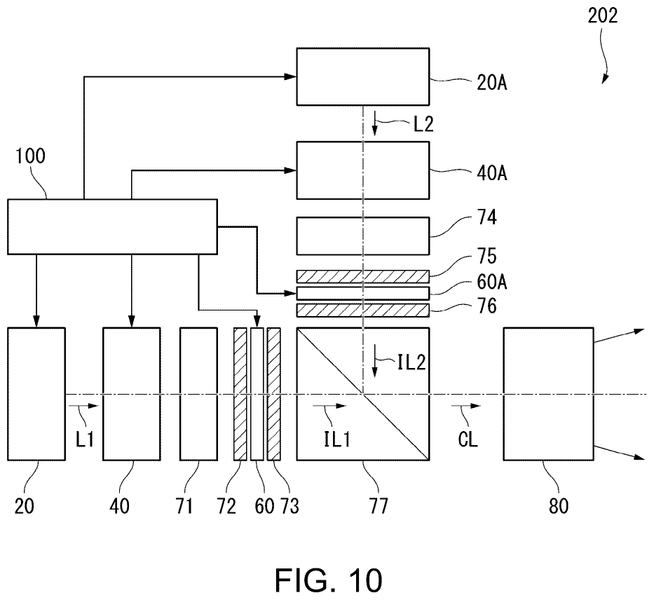

FIG. 10 is a schematic diagram of the projector 202 according to the fourth embodiment. The projector 202 is a two-plate type image display device including two liquid crystal panels as liquid crystal panels. The projector 202 includes the first light source device 20, the first light scanning device 40, the first liquid crystal panel 60, a P-polarization optical system 71, a first incident side polarizing plate 72, a first emission side polarizing plate 73, a second light source device 20A, a second light scanning device 40A, a second liquid crystal panel 60A, an S-polarization optical system 74, a second incident side polarizing plate 75, a second emission side polarizing plate 76, a light combining element 77, the projection optical system 80, and the control device 100, as illustrated in FIG. 10.

The first light source device 20 emits any one of red light RL, green light GL, and blue light BL as a first color light L1. The first light scanning device 40 scans the first color light L1 incident on the first liquid crystal panel 60 along the column direction of the first liquid crystal panel 60.

The P-polarization optical system 71 is disposed between the first light scanning device 40 and the first liquid crystal panel 60, and converts the first color light L1 incident on the first liquid crystal panel 60 into P-polarized light. The first incident side polarizing plate 72 is disposed on the incident side of the first liquid crystal panel 60, and the first emission side polarizing plate 73 is disposed on the emission side of the first liquid crystal panel 60. The first color light L1 converted into the P-polarized light is incident on the first liquid crystal panel 60 via the first incident side polarizing plate 72. The first image light IL1 generated by the first liquid crystal panel 60 modulating the first color light L1 is emitted to the light combining element 77 via the first emission side polarizing plate 73.

The second light source device 20A outputs any one of the red light RL, the green light GL, and the blue light BL as the second color light L2. The configuration of the second light source device 20A is the same as the configuration of the first light source device 20. The second light scanning device 40A scans the second color light L2 incident on the second liquid crystal panel 60A along the column direction of the second liquid crystal panel 60A. The configuration of the second light scanning device 40A is the same as the configuration of the first light scanning device 40. The second liquid crystal panel 60A is a liquid crystal panel that has the same configuration as the first liquid crystal panel 60. Accordingly, the second liquid crystal panel 60A has a plurality of lines arranged at predetermined intervals along the column direction and extending in the row direction.

The S-polarization optical system 74 is disposed between the second light scanning device 40A and the second liquid crystal panel 60A, and converts the second color light L2 incident on the second liquid crystal panel 60A into S-polarized light. The second incident side polarizing plate 75 is disposed on the incident side of the second liquid crystal panel 60A, and the second emission side polarizing plate 76 is disposed on the emission side of the second liquid crystal panel 60A. The second color light L2 converted into the S-polarized light is incident on the second liquid crystal panel 60A via the second incident side polarizing plate 75. The second image light IL2 generated by the second liquid crystal panel 60A modulating the second color light L2 is emitted to the light combining element 77 via the second emission side polarizing plate 76.

The light combining element 77 combines the first image light IL1, which is generated by the first liquid crystal panel 60 modulating the first color light L1, and the second image light IL2, which is generated by the second liquid crystal panel 60A modulating the second color light L2, with each other to generate a combined image light CL. The light combining element 77 emits the combined image light CL to the projection optical system 80. For example, the light combining element 77 is a dichroic prism. The projection optical system 80 enlarges and projects the combined image light CL generated by the light combining element 77 toward a projection surface such as a screen.

The control device 100 controls the first light source device 20, the first light scanning device 40, the first liquid crystal panel 60, the second light source device 20A, the second light scanning device 40A, and the second liquid crystal panel 60A.

For example, the control device 100 controls the first light source device 20, the first light scanning device 40, and the first liquid crystal panel 60 so as to operate according to the timing chart of FIG. 8 described in the second embodiment, and controls the second light source device 20A, the second light scanning device 40A, and the second liquid crystal panel 60A so as to operate according to the timing chart of FIG. 9 described in the third embodiment.

That is, the first light source device 20, the first light scanning device 40, and the first liquid crystal panel 60 are controlled to operate as follows according to the timing chart of FIG. 8 described in the second embodiment.

In the first subframe SF1, in the first liquid crystal panel 60, voltage corresponding to the first color data (in the present embodiment, the red data) is written to the pixels belonging to one or a plurality of lines (in the present embodiment, the first line) included in the first group, in the first liquid crystal panel 60, voltage corresponding to the second color data (in the present embodiment, the green data), which is different from the first color data, is written to the pixels belonging to one or a plurality of lines (in the present embodiment, the second line) included in the second group, and in the first liquid crystal panel 60, voltage corresponding to the third color data (in the present embodiment, the blue data), which is different from the first color data, and the second color data is written to the pixels belonging to one or a plurality of lines (in the present embodiment, the third line) included in the third group.

In the second subframe SF2, in the first liquid crystal panel 60, voltage corresponding to the second color data (in the present embodiment, the green data) is written to the pixels belonging to one or a plurality of lines (in the present embodiment, the first line) included in the first group, in the first liquid crystal panel 60, voltage corresponding to the third color data (in the present embodiment, the blue data) is written to the pixels belonging to one or a plurality of lines (in the present embodiment, the second line) included in the second group, and in the first liquid crystal panel 60, voltage corresponding to the second color data (in the present embodiment, the green data) is written to the pixels belonging to one or a plurality of lines (the third line in the present embodiment) included in the third group.

In the third subframe SF3, in the first liquid crystal panel 60, voltage corresponding to the third color data (in the present embodiment, the blue data) is written to the pixels belonging to one or a plurality of lines (the first line in the present embodiment) included in the first group, in the first liquid crystal panel 60, voltage corresponding to the second color data (in the present embodiment, the green data) is written to the pixels belonging to one or a plurality of lines (in the present embodiment, the second line) included in the second group, and in the first liquid crystal panel 60, voltage corresponding to the first color data (in the present embodiment, the red data) is written to the pixels belonging to one or a plurality of lines (in the present embodiment, the third line) included in the third group.

In the fourth subframe SF4, in the first liquid crystal panel 60, voltage corresponding to the second color data (in the present embodiment, the green data) is written to the pixels belonging to one or a plurality of lines (in the present embodiment, the first line) included in the first group, in the first liquid crystal panel 60, voltage corresponding to the first color data (in the present embodiment, the red data) is written to the pixels belonging to one or a plurality of lines (the second line in the present embodiment) included in the second group, and in the first liquid crystal panel 60, voltage corresponding to the second color data (in the present embodiment, the green data) is written to the pixels belonging to one or a plurality of lines (the third line in the present embodiment) included in the third group.

In each subframe, the first liquid crystal panel 60 is scanned with the first color light L1 incident thereon from the first line toward the last line, the first light source device 20 emits the red light RL as the first color light L1 in a period in which voltage corresponding to the red data is written in the first liquid crystal panel 60, the first light source device 20 emits the green light GL as the first color light L1 in a period in which voltage corresponding to the green data is written in the first liquid crystal panel 60, and the first light source device 20 emits the blue light BL as the first color light L1 in a period in which voltage corresponding to the blue data is written in the first liquid crystal panel 60.

The second light source device 20A, the second light scanning device 40A, and the second liquid crystal panel 60A are controlled to operate as follows according to the timing chart of FIG. 9 described in the third embodiment.

In the first subframe SF1, in the second liquid crystal panel 60A, voltage corresponding to the first color data (in the present embodiment, the red data) is written to the pixels belonging to one or a plurality of lines (in the present embodiment, the first line) included in the first group, in the second liquid crystal panel 60A, voltage corresponding to the second color data (in the present embodiment, a green data), which is different from the first color data, is written to the pixels belonging to one or a plurality of lines (in the present embodiment, the second line) included in the second group, and in the second liquid crystal panel 60A, voltage corresponding to the third color data (in the present embodiment, the blue data), which is different from the first color data and the second color data, is written to the pixels belonging to one or a plurality of lines (in the present embodiment, the third line) included in the third group.

In the second subframe SF2, in the second liquid crystal panel 60A, voltage corresponding to the second color data (in the present embodiment, the green data) is written to the pixels belonging to one or a plurality of lines (in the present embodiment, the first line) included in the first group, in the second liquid crystal panel 60A, voltage corresponding to the first color data (in the present embodiment, the red data) is written to the pixels belonging to one or a plurality of lines (in the present embodiment, the second line) included in the second group, and in the second liquid crystal panel 60A, voltage corresponding to the first color data (in the present embodiment, the red data) is written to the pixels belonging to one or a plurality of lines (in the present embodiment, the third line) included in the third group.

In the third subframe SF3, in the second liquid crystal panel 60A, voltage corresponding to the first color data (in the present embodiment, the red data) is written to the pixels belonging to one or a plurality of lines (in the present embodiment, the first line) included in the first group, in the second liquid crystal panel 60A, voltage corresponding to the third color data (in the present embodiment, the blue data) is written to the pixels belonging to one or a plurality of lines (in the present embodiment, the second line) included in the second group, and in the second liquid crystal panel 60A, voltage corresponding to the second color data (in the present embodiment, the green data) is written to the pixels belonging to one or a plurality of lines (in the present embodiment, the third line) included in the third group.

In the fourth subframe SF4, in the second liquid crystal panel 60A, the voltage corresponding to the third color data (in the present embodiment, the blue data) is written to the pixels belonging to one or a plurality of lines (in the present embodiment, the first line) included in the first group, in the second liquid crystal panel 60A, voltage corresponding to the first color data (in the present embodiment, the red data) is written to the pixels belonging to one or a plurality of lines (in the present embodiment, the second line) included in the second group, and in the second liquid crystal panel 60A, voltage corresponding to the first color data (in the present embodiment, the red data) is written to the pixels belonging to one or a plurality of lines (in the present embodiment, the third line) included in the third group.

In each subframe, the second liquid crystal panel 60A is scanned with the second color light L2 incident thereon from the first line toward the last line, the second light source device 20A emits the red light RL as the second color light L2 in a period in which voltage corresponding to the red data is written in the second liquid crystal panel 60A, the second light source device 20A emits the green light GL as the second color light L2 in a period in which voltage corresponding to the green data is written in the second liquid crystal panel 60A, and the second light source device 20A emits the blue light BL as the second color light L2 in a period in which voltage corresponding to the blue data is written in the second liquid crystal panel 60A.

According to the fourth embodiment, in one frame, the color of the first image light IL1 is recognized by the human in the order of white, cyan, white, and yellow, and the color of the second image light IL2 is recognized by the human in the order of white, yellow, white, and magenta. As a result, in one frame, since the combined image light CL is recognized by the human in the order of white, white, white, and white, even when the color rotation frequency is 60 Hz, color breakup can be reduced. That is, according to the fourth embodiment, both color gamut and brightness can be achieved while reducing color breakup.

Note that in the fourth embodiment, the control device 100 may control the first light source device 20, the first light scanning device 40, and the first liquid crystal panel 60 so as to operate according to the timing chart of FIG. 6 described in the first embodiment, and may control the second light source device 20A, the second light scanning device 40A, and the second liquid crystal panel 60A so as to operate according to the timing chart of FIG. 6.

### Fifth Embodiment

Next, a fifth embodiment of the present disclosure will be described. In the description of the fifth embodiment, the description of the contents common to the fourth embodiment will be omitted, and only the contents different from the fourth embodiment will be described. Further, regarding the configuration of a projector 203 according to the fifth embodiment, the same reference symbols as those of the corresponding configurations of the projector 202 according to the fourth embodiment are given to the configurations common to the projector 202 according to the fourth embodiment, and the description thereof will be omitted.

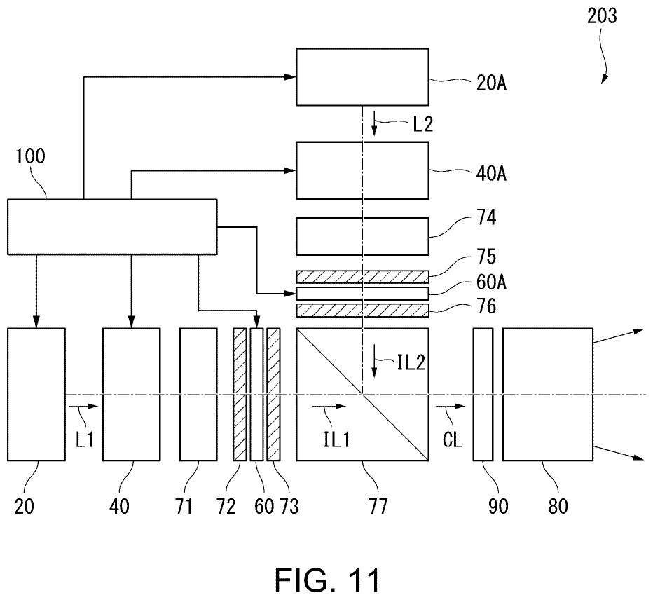

FIG. 11 is a schematic diagram of a projector 203 according to the fifth embodiment. As illustrated in FIG. 11, the projector 203 of the fifth embodiment differs from the projector 202 of the fourth embodiment in that it further includes an optical shift device 90 disposed between the light combining element 77 and the projection optical system 80.

The optical shift device 90 shifts the optical path of the combined image light CL emitted from the light combining element 77. The optical shift device 90 may be a biaxial shift device that shifts the optical path of the combined image light CL along two axes. The specific configuration of the biaxial shift device is known as described in JP-A-2022-82000. Therefore, in the present specification, a description of a specific configuration of the biaxial shift device will be omitted.

The optical shift device 90 may be a uniaxial shift device that shifts the optical path of the combined image light CL along one axis. The specific configuration of the uniaxial shift device is known as described in JP-A-2018-54974. Therefore, in the present specification, a description of a specific configuration of the uniaxial shift device will be omitted.

By disposing the optical shift device 90 described above between the light combining element 77 and the projection optical system 80, it is possible to realize the high definition of the image projected on the projection surface by the projector 203.

Although the preferred embodiments of the present disclosure have been described in detail above, the present disclosure is not limited to the specific embodiments, and various modifications and changes can be made within the scope of the gist of the present disclosure described in the claims. The constituent elements of the plurality of embodiments can be appropriately combined.

### SUMMARY OF PRESENT DISCLOSURE

Hereinafter, an outline of the present disclosure is appended.

### Appendix 1

A projector includes a first light source device configured to emit any one of red light, green light, and blue light as first color light; a first liquid crystal panel having a plurality of lines that are arranged at predetermined intervals along a column direction and that extend in a row direction, and in which the lines are defined as an array of pixels connected to one scanning line; and a first light scanning device configured to scan the first color light incident on the first liquid crystal panel along the column direction of the first liquid crystal panel, wherein in each of a plurality of subframes included in one frame, in the first liquid crystal panel, voltage corresponding to color data of any one of red data, green data, and blue data is written to the pixels belonging to each line in order from a first line toward a last line and also voltage corresponding to different color data is written for each of one or a plurality of lines, the first color light incident on the first liquid crystal panel is scanned from the first line toward the last line, in the first liquid crystal panel, the red light is emitted from the first light source device as the first color light in a period in which voltage corresponding to the red data is written, in the first liquid crystal panel, the green light is emitted from the first light source device as the first color light in a period in which voltage corresponding to the green data is written, and in the first liquid crystal panel, the blue light is emitted from the first light source device as the first color light in a period in which voltage corresponding to the blue data is written.

According to the projector of Appendix 1, since the color of the first image light is recognized as white by the human in each of the subframes included in one frame, even when the color rotation frequency is 60 Hz, color breakup can be reduced. That is, according to the projector of Appendix 1, both color gamut and brightness can be achieved while reducing color breakup.

### Appendix 2

The projector according to Appendix 1, wherein the one frame includes a first subframe, a second subframe, and a third subframe, in the first subframe, in the first liquid crystal panel, voltage corresponding to first color data is written to the pixels belonging to one or a plurality of lines included in a first group, in the first liquid crystal panel, voltage corresponding to second color data different from the first color data is written to the pixels belonging to one or a plurality of lines included in a second group, and in the first liquid crystal panel, voltage corresponding to third color data different from the first color data and the second color data is written to the pixels belonging to one or a plurality of lines included in a third group, in the second subframe, in the first liquid crystal panel, voltage corresponding to the second color data is written to the pixels belonging to one or a plurality of lines included in the first group, in the first liquid crystal panel, voltage corresponding to the third color data is written to the pixels belonging to one or a plurality of lines included in the second group, and in the first liquid crystal panel, voltage corresponding to the first color data is written to the pixels belonging to one or a plurality of lines included in the third group, in the third subframe, in the first liquid crystal panel, voltage corresponding to the third color data is written to the pixels belonging to one or a plurality of lines included in the first group, in the first liquid crystal panel, voltage corresponding to the first color data is written to the pixels belonging to one or a plurality of lines included in the second group, and in the first liquid crystal panel, voltage corresponding to the second color data is written to the pixels belonging to one or a plurality of lines included in the third group, and each of the first color data, the second color data, and the third color data is one of the red data, the green data, and the blue data.

According to the projector of Appendix 2, in one frame including three subframes, the colors of the first image light are recognized by the human in the order of white, white, and white, and thus, even when the color rotation frequency is 60 Hz, both color gamut and brightness can be achieved while reducing color breakup.

### Appendix 3

The projector according to Appendix 1, wherein the one frame includes a first subframe, a second subframe, a third subframe, and a fourth subframe, in the first subframe, in the first liquid crystal panel, voltage corresponding to first color data is written to the pixels belonging to one or a plurality of lines included in a first group, in the first liquid crystal panel, voltage corresponding to second color data different from the first color data is written to the pixels belonging to one or a plurality of lines included in a second group, and in the first liquid crystal panel, voltage corresponding to third color data different from the first color data and the second color data is written to the pixels belonging to one or a plurality of lines included in a third group, in the second subframe, in the first liquid crystal panel, voltage corresponding to the second color data is written to the pixels belonging to one or a plurality of lines included in the first group, in the first liquid crystal panel, voltage corresponding to the third color data is written to the pixels belonging to one or a plurality of lines included in the second group, and in the first liquid crystal panel, voltage corresponding to the second color data is written to the pixels belonging to one or a plurality of lines included in the third group, in the third subframe, in the first liquid crystal panel, voltage corresponding to the third color data is written to the pixels belonging to one or a plurality of lines included in the first group, in the first liquid crystal panel, voltage corresponding to the second color data is written to the pixels belonging to one or a plurality of lines included in the second group, and in the first liquid crystal panel, voltage corresponding to the first color data is written to the pixels belonging to one or a plurality of lines included in the third group, in the fourth subframe, in the first liquid crystal panel, voltage corresponding to the second color data is written to the pixels belonging to one or a plurality of lines included in the first group, in the first liquid crystal panel, voltage corresponding to the first color data is written to the pixels belonging to one or a plurality of lines included in the second group, and in the first liquid crystal panel, voltage corresponding to the second color data is written to the pixels belonging to one or a plurality of lines included in the third group, and each of the first color data, the second color data, and the third color data is one of the red data, the green data, and the blue data.

According to the projector of Appendix 3, in one frame, the color of the first image light is recognized by the human in the order of white, cyan (complementary color), white, and yellow (complementary color). As described above, in the projector according to the Appendix 3, since the complementary colors are mixed in the colors recognized by the human in one frame, the effect of reducing color breakup is lower than that of the projector according to the Appendix 2. However, in the projector according to the Appendix 3, since the light emission period of green in one frame is longer than that in the projector according to Appendix 2, the brightness of the image recognized by the human can be improved.

### Appendix 4

The projector according to Appendix 1, wherein the one frame includes a first subframe, a second subframe, a third subframe, and a fourth subframe, in the first subframe, in the first liquid crystal panel, voltage corresponding to first color data is written to the pixels belonging to one or a plurality of lines included in a first group, in the first liquid crystal panel, voltage corresponding to second color data different from the first color data is written to the pixels belonging to one or a plurality of lines included in a second group, and in the first liquid crystal panel, voltage corresponding to third color data different from the first color data and the second color data is written to the pixels belonging to one or a plurality of lines included in a third group, in the second subframe, in the first liquid crystal panel, voltage corresponding to the second color data is written to the pixels belonging to one or a plurality of lines included in the first group, in the first liquid crystal panel, voltage corresponding to the first color data is written to the pixels belonging to one or a plurality of lines included in the second group, and in the first liquid crystal panel, voltage corresponding to the first color data is written to the pixels belonging to one or a plurality of lines included in the third group, in the third subframe, in the first liquid crystal panel, voltage corresponding to the first color data is written to the pixels belonging to one or a plurality of lines included in the first group, in the first liquid crystal panel, voltage corresponding to the third color data is written to the pixels belonging to one or a plurality of lines included in the second group, and in the first liquid crystal panel, voltage corresponding to the second color data is written to the pixels belonging to one or a plurality of lines included in the third group, in the fourth subframe, in the first liquid crystal panel, voltage corresponding to the third color data is written to the pixels belonging to one or a plurality of lines included in the first group, in the first liquid crystal panel, voltage corresponding to the first color data is written to the pixels belonging to one or a plurality of lines included in the second group, and in the first liquid crystal panel, voltage corresponding to the first color data is written to the pixels belonging to one or a plurality of lines included in the third group, and each of the first color data, the second color data, and the third color data is one of the red data, the green data, and the blue data.

According to the projector of Appendix 4, in one frame, the color of the first image light is recognized by the human in the order of white, yellow (complementary color), white, and magenta (complementary color). As described above, in the projector according to the Appendix 4, since the complementary colors are mixed in the colors recognized by the human in one frame, the effect of reducing color breakup is lower than that of the projector according to the Appendix 2. However, in the projector according to the Appendix 4, since the light emission period of red in one frame is longer than that in the projector according to the Appendix 2, the white balance of the image recognized by the human can be improved.

### Appendix 5

The projector according to any one of Appendix 1 to Appendix 4, wherein each of the plurality of subframes includes an odd-numbered field that is a first half period and an even-numbered field that is a second half period, in the odd-numbered fields, in the first liquid crystal panel, voltage that corresponds to different color data for each of the one or a plurality of lines and that has a first polarity is written and emission of the first color light from the first light source device is stopped and in the even-numbered fields, in the first liquid crystal panel, voltage that corresponds to different color data for each of the one or a plurality of lines and that has a second polarity opposite to the first polarity is written and the first color light incident on the first liquid crystal panel is scanned from the first line toward the last line.

According to the projector of Appendix 5, since the first light source device emits the first color light in the even-numbered field included in each subframe, that is, only in the period in which the voltage of the second polarity is written, the occurrence of crosstalk in the projection image can be suppressed.

### Appendix 6

The projector according to Appendix 1, further including a second light source device configured to emit any one of the red light, the green light, and the blue light as a second color light; a second liquid crystal panel having a plurality of lines that are arranged at predetermined intervals along the column direction and that extend in the row direction, and in which the lines are defined as an array of pixels connected to one scanning line; a second light scanning device configured to scan the second color light incident on the second liquid crystal panel along the column direction of the second liquid crystal panel; and a light combining element configured to generate a combined image light by combining a first image light generated by modulating the first color light by the first liquid crystal panel and a second image light generated by modulating the second color light by the second liquid crystal panel, wherein in each of the plurality of subframes, in the second liquid crystal panel, voltage that corresponds to color data of any one of the red data, the green data, and the blue data is written to the pixels belonging to each line in order from a first line toward a last line and also voltage that corresponds to different color data is written for each of one or a plurality of lines, the second color light incident on the second liquid crystal panel is scanned from the first line toward the last line, in the second liquid crystal panel, the red light is emitted from the second light source device as the second color light in a period in which voltage corresponding to the red data is written, in the second liquid crystal panel, the green light is emitted from the second light source device as the second color light in a period in which voltage corresponding to the green data is written, and in the second liquid crystal panel, the blue light is emitted from the second light source device as the second color light in a period in which voltage corresponding to the blue data is written.

According to the projector of Appendix 6, it is possible to improve brightness of the combined image light projected from the projector, and both color gamut and brightness can be achieved while reducing color breakup.

### Appendix 7

The projector according to Appendix 6, wherein the one frame includes a first subframe, a second subframe, a third subframe, and a fourth subframe, in the first subframe, in the first liquid crystal panel and the second liquid crystal panel, voltage corresponding to the first color data is written to the pixel belonging to one or a plurality of lines included in the first group, in the first liquid crystal panel and the second liquid crystal panel, voltage corresponding to the second color data different from the first color data is written to the pixels belonging to one or a plurality of lines included in the second group, and in the first liquid crystal panel and the second liquid crystal panel, voltage corresponding to the third color data different from the first color data and the second color data is written to the pixels belonging to one or a plurality of lines included in the third group, in the second subframe, in the first liquid crystal panel, voltage corresponding to the second color data is written to the pixels belonging to one or a plurality of lines included in the first group, in the first liquid crystal panel, voltage corresponding to the third color data is written to the pixels belonging to one or a plurality of lines included in the second group, in the first liquid crystal panel, voltage corresponding to the second color data is written to the pixels belonging to one or a plurality of lines included in the third group, in the second liquid crystal panel, voltage corresponding to the second color data is written to the pixels belonging to one or a plurality of lines included in the first group, in the second liquid crystal panel, voltage corresponding to the first color data is written to the pixels belonging to one or a plurality of lines included in the second group, and in the second liquid crystal panel, voltage corresponding to the first color data is written to the pixels belonging to one or a plurality of lines included in the third group, and in the third subframe, in the first liquid crystal panel, voltage corresponding to the third color data is written to the pixels belonging to one or a plurality of lines included in the first group, in the first liquid crystal panel, voltage corresponding to the second color data is written to the pixels belonging to one or a plurality of lines included in the second group, in the first liquid crystal panel, voltage corresponding to the first color data is written to the pixels belonging to one or a plurality of lines included in the third group, in the second liquid crystal panel, voltage corresponding to the first color data is written to the pixels belonging to one or a plurality of lines included in the first group, in the second liquid crystal panel, voltage corresponding to the third color data is written to the pixels belonging to one or a plurality of lines included in the second group, and in the second liquid crystal panel, voltage corresponding to the second color data is written to the pixels belonging to one or a plurality of lines included in the third group, in the fourth subframe, in the first liquid crystal panel, voltage corresponding to the second color data is written to the pixels belonging to one or a plurality of lines included in the first group, in the first liquid crystal panel, voltage corresponding to the first color data is written to the pixels belonging to one or a plurality of lines included in the second group, in the first liquid crystal panel, voltage corresponding to the second color data is written to the pixels belonging to one or a plurality of lines included in the third group, in the second liquid crystal panel, voltage corresponding to the third color data is written to the pixels belonging to one or a plurality of lines included in the first group, in the second liquid crystal panel, voltage corresponding to the first color data is written to the pixels belonging to one or a plurality of lines included in the second group, and in the second liquid crystal panel, voltage corresponding to the first color data is written to the pixels belonging to one or a plurality of lines included in the third group, and each of the first color data, the second color data, and the third color data is one of the red data, the green data, and the blue data.

According to the projector of Appendix 7, in one frame, the color of the first image light is recognized by the human in the order of white, cyan, white, and yellow, and the color of the second image light is recognized by the human in the order of white, yellow, white, and magenta. As a result, in one frame, since the combined image light is recognized by the human in the order of white, white, white, and white, even when the color rotation frequency is 60 Hz, color breakup can be reduced. That is, according to the projector of Appendix 7, both color gamut and brightness can be achieved while reducing color breakup.

### Appendix 8

The projector according to Appendix 6 or the Appendix 7, further including an optical shift device configured to shift an optical path of the combined image light emitted from the light combining element.

According to the projector of the Appendix 8, since the optical shift device for shifting the optical path of the combined image light emitted from the light combining element is provided, it is possible to realize the high definition of the image projected on the projection surface by the projector.

What is claimed is:

1. A projector comprising:
a first light source device configured to emit any one of red light, green light, and blue light as first color light;
a first liquid crystal panel having a plurality of lines that are arranged at predetermined intervals along a column direction and that extend in a row direction, and in which the lines are defined as an array of pixels connected to one scanning line; and
a first light scanning device configured to scan the first color light incident on the first liquid crystal panel along the column direction of the first liquid crystal panel, wherein in each of a plurality of subframes included in one frame,
in the first liquid crystal panel, voltage corresponding to color data of any one of red data, green data, and blue data is written to the pixels belonging to each line in order from a first line toward a last line and also voltage corresponding to different color data is written for each of one or a plurality of lines,
the first color light incident on the first liquid crystal panel is scanned from the first line toward the last line,
in the first liquid crystal panel, the red light is emitted from the first light source device as the first color light in a period in which voltage corresponding to the red data is written,
in the first liquid crystal panel, the green light is emitted from the first light source device as the first color light in a period in which voltage corresponding to the green data is written, and
in the first liquid crystal panel, the blue light is emitted from the first light source device as the first color light in a period in which voltage corresponding to the blue data is written.

2. The projector according to claim 1, wherein
the one frame includes a first subframe, a second subframe, and a third subframe,
in the first subframe,
in the first liquid crystal panel, voltage corresponding to first color data is written to the pixels belonging to one or a plurality of lines included in a first group,
in the first liquid crystal panel, voltage corresponding to second color data different from the first color data is written to the pixels belonging to one or a plurality of lines included in a second group, and
in the first liquid crystal panel, voltage corresponding to third color data different from the first color data and the second color data is written to the pixels belonging to one or a plurality of lines included in a third group,
in the second subframe,
in the first liquid crystal panel, voltage corresponding to the second color data is written to the pixels belonging to one or a plurality of lines included in the first group,
in the first liquid crystal panel, voltage corresponding to the third color data is written to the pixels belonging to one or a plurality of lines included in the second group, and
in the first liquid crystal panel, voltage corresponding to the first color data is written to the pixels belonging to one or a plurality of lines included in the third group,
in the third subframe,
in the first liquid crystal panel, voltage corresponding to the third color data is written to the pixels belonging to one or a plurality of lines included in the first group,
in the first liquid crystal panel, voltage corresponding to the first color data is written to the pixels belonging to one or a plurality of lines included in the second group, and
in the first liquid crystal panel, voltage corresponding to the second color data is written to the pixels belonging to one or a plurality of lines included in the third group, and
each of the first color data, the second color data, and the third color data is one of the red data, the green data, and the blue data.

3. The projector according to claim 1, wherein
the one frame includes a first subframe, a second subframe, a third subframe, and a fourth subframe,
in the first subframe,
in the first liquid crystal panel, voltage corresponding to first color data is written to the pixels belonging to one or a plurality of lines included in a first group,
in the first liquid crystal panel, voltage corresponding to second color data different from the first color data is written to the pixels belonging to one or a plurality of lines included in a second group, and
in the first liquid crystal panel, voltage corresponding to third color data different from the first color data and the second color data is written to the pixels belonging to one or a plurality of lines included in a third group,
in the second subframe,
in the first liquid crystal panel, voltage corresponding to the second color data is written to the pixels belonging to one or a plurality of lines included in the first group,
in the first liquid crystal panel, voltage corresponding to the third color data is written to the pixels belonging to one or a plurality of lines included in the second group, and
in the first liquid crystal panel, voltage corresponding to the second color data is written to the pixels belonging to one or a plurality of lines included in the third group,
in the third subframe,
in the first liquid crystal panel, voltage corresponding to the third color data is written to the pixels belonging to one or a plurality of lines included in the first group,
in the first liquid crystal panel, voltage corresponding to the second color data is written to the pixels belonging to one or a plurality of lines included in the second group, and
in the first liquid crystal panel, voltage corresponding to the first color data is written to the pixels belonging to one or a plurality of lines included in the third group,
in the fourth subframe,
in the first liquid crystal panel, voltage corresponding to the second color data is written to the pixels belonging to one or a plurality of lines included in the first group,
in the first liquid crystal panel, voltage corresponding to the first color data is written to the pixels belonging to one or a plurality of lines included in the second group, and
in the first liquid crystal panel, voltage corresponding to the second color data is written to the pixels belonging to one or a plurality of lines included in the third group, and
each of the first color data, the second color data, and the third color data is one of the red data, the green data, and the blue data.

4. The projector according to claim 1, wherein
the one frame includes a first subframe, a second subframe, a third subframe, and a fourth subframe,
in the first subframe,
in the first liquid crystal panel, voltage corresponding to first color data is written to the pixels belonging to one or a plurality of lines included in a first group,
in the first liquid crystal panel, voltage corresponding to second color data different from the first color data is written to the pixels belonging to one or a plurality of lines included in a second group, and
in the first liquid crystal panel, voltage corresponding to third color data different from the first color data and the second color data is written to the pixels belonging to one or a plurality of lines included in a third group,
in the second subframe,
in the first liquid crystal panel, voltage corresponding to the second color data is written to the pixels belonging to one or a plurality of lines included in the first group,
in the first liquid crystal panel, voltage corresponding to the first color data is written to the pixels belonging to one or a plurality of lines included in the second group, and
in the first liquid crystal panel, voltage corresponding to the first color data is written to the pixels belonging to one or a plurality of lines included in the third group,
in the third subframe,
in the first liquid crystal panel, voltage corresponding to the first color data is written to the pixels belonging to one or a plurality of lines included in the first group,
in the first liquid crystal panel, voltage corresponding to the third color data is written to the pixels belonging to one or a plurality of lines included in the second group, and
in the first liquid crystal panel, voltage corresponding to the second color data is written to the pixels belonging to one or a plurality of lines included in the third group,
in the fourth subframe,
in the first liquid crystal panel, voltage corresponding to the third color data is written to the pixels belonging to one or a plurality of lines included in the first group,
in the first liquid crystal panel, voltage corresponding to the first color data is written to the pixels belonging to one or a plurality of lines included in the second group, and
in the first liquid crystal panel, voltage corresponding to the first color data is written to the pixels belonging to one or a plurality of lines included in the third group, and
each of the first color data, the second color data, and the third color data is one of the red data, the green data, and the blue data.

5. The projector according to claim 1, wherein
each of the plurality of subframes includes an odd-numbered field that is a first half period and an even-numbered field that is a second half period,
in the odd-numbered fields,
in the first liquid crystal panel, voltage that corresponds to different color data for each of the one or a plurality of lines and that has a first polarity is written and
emission of the first color light from the first light source device is stopped and
in the even-numbered fields,
in the first liquid crystal panel, voltage that corresponds to different color data for each of the one or a plurality of lines and that has a second polarity opposite to the first polarity is written and
the first color light incident on the first liquid crystal panel is scanned from the first line toward the last line.

6. The projector according to claim 1, further comprising:
a second light source device configured to emit any one of the red light, the green light, and the blue light as a second color light;
a second liquid crystal panel having a plurality of lines that are arranged at predetermined intervals along the column direction and that extend in the row direction, and in which the lines are defined as an array of pixels connected to one scanning line;
a second light scanning device configured to scan the second color light incident on the second liquid crystal panel along the column direction of the second liquid crystal panel; and
a light combining element configured to generate a combined image light by combining a first image light generated by modulating the first color light by the first liquid crystal panel and a second image light generated by modulating the second color light by the second liquid crystal panel, wherein
in each of the plurality of subframes,
in the second liquid crystal panel, voltage that corresponds to color data of any one of the red data, the green data, and the blue data is written to the pixels belonging to each line in order from a first line toward a last line and also voltage that corresponds to different color data is written for each of one or a plurality of lines,
the second color light incident on the second liquid crystal panel is scanned from the first line toward the last line,
in the second liquid crystal panel, the red light is emitted from the second light source device as the second color light in a period in which voltage corresponding to the red data is written,
in the second liquid crystal panel, the green light is emitted from the second light source device as the second color light in a period in which voltage corresponding to the green data is written, and
in the second liquid crystal panel, the blue light is emitted from the second light source device as the second color light in a period in which voltage corresponding to the blue data is written.

7. The projector according to claim 6, wherein
the one frame includes a first subframe, a second subframe, a third subframe, and a fourth subframe,
in the first subframe,
in the first liquid crystal panel and the second liquid crystal panel, voltage corresponding to the first color data is written to the pixel belonging to one or a plurality of lines included in the first group,
in the first liquid crystal panel and the second liquid crystal panel, voltage corresponding to the second color data different from the first color data is written to the pixels belonging to one or a plurality of lines included in the second group, and
in the first liquid crystal panel and the second liquid crystal panel, voltage corresponding to the third color data different from the first color data and the second color data is written to the pixels belonging to one or a plurality of lines included in the third group,
in the second subframe,
in the first liquid crystal panel, voltage corresponding to the second color data is written to the pixels belonging to one or a plurality of lines included in the first group,
in the first liquid crystal panel, voltage corresponding to the third color data is written to the pixels belonging to one or a plurality of lines included in the second group,
in the first liquid crystal panel, voltage corresponding to the second color data is written to the pixels belonging to one or a plurality of lines included in the third group,
in the second liquid crystal panel, voltage corresponding to the second color data is written to the pixels belonging to one or a plurality of lines included in the first group,
in the second liquid crystal panel, voltage corresponding to the first color data is written to the pixels belonging to one or a plurality of lines included in the second group, and
in the second liquid crystal panel, voltage corresponding to the first color data is written to the pixels belonging to one or a plurality of lines included in the third group,
in the third subframe,
in the first liquid crystal panel, voltage corresponding to the third color data is written to the pixels belonging to one or a plurality of lines included in the first group,
in the first liquid crystal panel, voltage corresponding to the second color data is written to the pixels belonging to one or a plurality of lines included in the second group,
in the first liquid crystal panel, voltage corresponding to the first color data is written to the pixels belonging to one or a plurality of lines included in the third group,
in the second liquid crystal panel, voltage corresponding to the first color data is written to the pixels belonging to one or a plurality of lines included in the first group,
in the second liquid crystal panel, voltage corresponding to the third color data is written to the pixels belonging to one or a plurality of lines included in the second group, and
in the second liquid crystal panel, voltage corresponding to the second color data is written to the pixels belonging to one or a plurality of lines included in the third group,
in the fourth subframe,
in the first liquid crystal panel, voltage corresponding to the second color data is written to the pixels belonging to one or a plurality of lines included in the first group,
in the first liquid crystal panel, voltage corresponding to the first color data is written to the pixels belonging to one or a plurality of lines included in the second group,
in the first liquid crystal panel, voltage corresponding to the second color data is written to the pixels belonging to one or a plurality of lines included in the third group,
in the second liquid crystal panel, voltage corresponding to the third color data is written to the pixels belonging to one or a plurality of lines included in the first group,
in the second liquid crystal panel, voltage corresponding to the first color data is written to the pixels belonging to one or a plurality of lines included in the second group, and
in the second liquid crystal panel, voltage corresponding to the first color data is written to the pixels belonging to one or a plurality of lines included in the third group, and
each of the first color data, the second color data, and the third color data is one of the red data, the green data, and the blue data.

8. The projector according to claim 6, further comprising:
an optical shift device configured to shift an optical path of the combined image light emitted from the light combining element.
